(19) United States
(12) Patent Application Publication
(10) Pub. No.: US 2025/0286697 A1
(43) Pub. Date: Sep. 11, 2025

(54) SIGNAL PROCESSING SYSTEM, MULTI-SIGNAL PROCESSING SYSTEM, SIGNAL PROCESSING METHOD, AND SIGNAL PROCESSING PROGRAM

(71) Applicant: NEC Corporation, Tokyo (JP)

(72) Inventor: Takahiro ODAGAWA, Tokyo (JP)

(73) Assignee: NEC Corporation, Tokyo (JP)

(21) Appl. No.: 19/066,594

(22) Filed: Feb. 28, 2025

(30) Foreign Application Priority Data
Mar. 11, 2024 (JP) 2024-036879

(51) Int. Cl. H04L 7/02; H04B 10/25

(52) U.S. Cl. CPC H04L 7/02; H04B 10/25

(57) ABSTRACT

A cross-correlation calculation unit calculates a cross-correlation spectrum representing similarity between each of multiple received signals, which have a temporal spread and are coupled to each other during propagation, and a pilot signal included in part of each of the received signals. A correlation shaping processing unit performs arithmetic processing that shapes the peak of the cross-correlation spectrum so that it becomes higher than an original peak. A first peak determination processing unit detects the peak of the cross-correlation spectrum after arithmetic processing. A synchronization processing unit performs time alignment that aligns a time origin to synchronize the pilot signal and the received signal by using the detected peak.

### CROSS-REFERENCE TO RELATED APPLICATIONS

This application is based upon and claims the benefit of priority from the prior Japanese Patent Application No. 2024-36879, filed Mar. 11, 2024, the entire contents of which are incorporated herein by reference.

### BACKGROUND OF THE INVENTION

The present disclosure relates to a signal processing system, a multi-signal processing system, a signal processing method, and a signal processing program for processing optical signals.

In an optical communication transmission system that uses an optical fiber in which spatial mode dispersion (SMD) occurs, time alignment is performed by using a known signal. One example of such a known signal is a pilot signal.

Patent Literature 1 discloses a method that uses cross-correlation when establishing synchronization of a transmitter and receiver by using a preamble. In the method described in Patent Literature 1, cross-correlation between the received signal and the preamble is calculated, and when that value exceeds a predetermined threshold, the peak of the cross-correlation is detected and synchronization is established. Here, the threshold is determined empirically based on Monte Carlo simulation.

### PRIOR ART DOCUMENTS

[Patent Literature 1] Patent Abstracts of Japan No. 2010-531572

### SUMMARY OF THE INVENTION

There is a problem that under conditions where the peak of the cross-correlation becomes low, the success rate of time alignment using cross-correlation decreases. The reason for this is that under such conditions, it is difficult or impossible to determine an appropriate threshold.

Therefore, it is an exemplary object of the present disclosure to provide a signal processing system, a multi-signal processing system, a signal processing method, and a signal processing program that can suppress a decrease in the success rate of time alignment even under conditions where the peak of the cross-correlation becomes low.

The signal processing system according to the present disclosure includes: a cross-correlation calculation unit configured to calculate a cross-correlation spectrum representing similarity between each of multiple received signals, which have a temporal spread and are coupled to each other during propagation, and a pilot signal included in part of each of the received signals; a correlation shaping processing unit configured to perform arithmetic processing that shapes the peak of the cross-correlation spectrum so that it becomes higher than an original peak; a first peak determination processing unit configured to detect the peak of the cross-correlation spectrum after the arithmetic processing; and a synchronization processing unit configured to perform time alignment that aligns a time origin to synchronize the pilot signal and the received signals by using the detected peak.

The multi-signal processing system according to the present disclosure is configured such that the above-described signal processing system is arranged in parallel, and at least one of a parameter indicating characteristics of a transmission system or information indicating a modulation scheme of the pilot signal is input to each signal processing system.

The signal processing method according to the present disclosure includes: calculating a cross-correlation spectrum representing similarity between each of multiple received signals, which have a temporal spread and are coupled to each other during propagation, and a pilot signal included in part of each of the received signals; performing arithmetic processing that shapes the peak of the cross-correlation spectrum so that it becomes higher than an original peak; detecting the peak of the cross-correlation spectrum after the arithmetic processing; and performing time alignment that aligns a time origin to synchronize the pilot signal and the received signals by using the detected peak.

The signal processing program according to the present disclosure causes a computer to execute: a cross-correlation calculation process of calculating a cross-correlation spectrum representing similarity between each of multiple received signals, which have a temporal spread and are coupled to each other during propagation, and a pilot signal included in part of each of the received signals; a correlation shaping process of performing arithmetic processing that shapes the peak of the cross-correlation spectrum so that it becomes higher than an original peak; a first peak determination process of detecting the peak of the cross-correlation spectrum after the arithmetic processing; and a synchronization process of performing time alignment that aligns a time origin to synchronize the pilot signal and the received signals by using the detected peak.

According to the present disclosure, even under conditions where the peak of the cross-correlation becomes low, it is possible to suppress a decrease in the success rate of time alignment.

### BRIEF DESCRIPTION OF DRAWINGS

FIG. 1 is a block diagram showing a configuration example of the signal processing system of the present disclosure.

FIG. 2 is a flowchart showing an example of operation of the signal processing system of the present disclosure.

FIG. 3 is a block diagram showing another configuration example of the signal processing system of the present disclosure.

FIG. 4 is a flowchart showing another example of operation of the signal processing system of the present disclosure.

FIG. 5 is a block diagram showing another configuration example of the signal processing system of the present disclosure.

FIG. 6 is a flowchart showing another example of operation of the signal processing system of the present disclosure.

FIG. 7 is a block diagram showing another configuration example of the signal processing system of the present disclosure.

FIG. 8 is a flowchart showing another example of operation of the signal processing system of the present disclosure.

FIG. 9 is an explanatory diagram showing a configuration example using a signal processing device.

FIG. 10 is an explanatory diagram showing an example of a received signal.

FIG. 11 is a block diagram showing a configuration example of a time alignment device.

FIG. 12 is a flowchart showing an example of operation of the time alignment device.

FIG. 13 is an explanatory diagram showing an example of changes in the success rate of peak determination.

FIG. 14 is an explanatory diagram showing another configuration example using a signal processing device.

FIG. 15 is a block diagram showing another configuration example of a time alignment device.

FIG. 16 is a flowchart showing another example of operation of the time alignment device.

FIG. 17 is an explanatory diagram showing an example of changes in the success rate of peak determination when the shaping parameter is varied.

FIG. 18 is an explanatory diagram showing another configuration example using a signal processing device.

FIG. 19 is a block diagram showing another configuration example of a time alignment device.

FIG. 20 is a flowchart showing another example of operation of the time alignment device.

FIG. 21 is an explanatory diagram showing another configuration example using a signal processing device.

FIG. 22 is a block diagram showing another configuration example of a time alignment device.

FIG. 23 is a flowchart showing another example of operation of the time alignment device.

FIG. 24 is a block diagram showing an overview of the signal processing system according to the present disclosure.

FIG. 25 is a block diagram showing an overview of the multi-signal processing system according to the present disclosure.

FIG. 26 is a schematic block diagram showing a configuration of a computer according to at least one example embodiment.

### DETAILED DESCRIPTION OF THE INVENTION

First, a method for performing time synchronization between a received signal and a known signal will be explained. In recent years, as a technology for expanding communication capacity, MIMO (Multiple-Input Multiple-Output) technology has been developed for optical fiber communications. In optical communications, MIMO is used in polarization multiplexing in a single-mode fiber, and also in a multi-mode fiber (MMF; MultiMode Fiber) or a multi-core fiber (MCF; Multi Core Fiber), thereby achieving an increase in communication capacity and higher communication speed.

In MIMO processing for optical communications, multiple modes (polarization, propagation mode, or core) of received signals are input, and an output signal is obtained in which crosstalk between modes and distortion introduced during propagation are compensated. In particular, for MIMO processing in optical communications using coupled MCF, data-aided processing that uses a pilot signal is under study (for example, refer to Reference 1 below). <Reference 1> M. Arikawa et al., “Long-Haul WDM/SDM Transmission Over Coupled 4-Core Fibers Installed in Submarine Cable,” in Journal of Lightwave Technology, vol. 41, no. 6, pp. 1649-1657

In data-aided processing, the pilot signal is included in the transmitted signal. Stable compensation is achieved by initial convergence of the filter in the MIMO processing to restore the crosstalk and distorted pilot signal to the original pilot signal, and then switching to a BLIND-type adaptive equivalent that does not use the pilot signal.

To perform data-aided processing, it is necessary to identify the portion in the received signal that corresponds to the pilot signal, which has been distorted, and then perform time alignment to align the time origin with the pilot signal. One approach to such time alignment is to use cross-correlation. An example of such a signal processing method is disclosed in Patent Literature 1 and in Reference 2 below.

<Reference 2>Japanese Unexamined Patent Application Publication No. 2005-064567

Reference 2 discloses a technique for performing time synchronization between a received signal and a known signal by computing cross-correlation between the received signal and the known signal, and then averaging the calculated cross-correlation to obtain a moving average value so as to mitigate the effect of noise mixed into the signal. In communications, it is desirable that the pilot signal be as short as possible because the pilot signal is used only for time alignment or data-aided processing and does not actually transmit information. While using a short pilot signal makes it possible to increase transmission capacity, if the pilot signal is not sufficiently long, the peak of the cross-correlation becomes lower and the success rate of time alignment is reduced.

In addition to the case where the pilot signal is short, large SMD, a high number of modes coupled by crosstalk, and other conditions can also reduce the peak height. Especially in data-aided processing for long-distance optical communications using coupled MCF, the length of the pilot signal, the amount of SMD, and the number of coupled modes all affect the peak height.

While a simple moving average of the cross-correlation, as disclosed in Reference 2, can mitigate the effect of noise mixed in the signal, it does not aim to improve the success rate of time alignment under conditions where the peak height becomes low.

Therefore, in the present disclosure, a method that can suppress a decrease in the success rate of time alignment even under conditions where the peak of the cross-correlation becomes low will be explained.

Hereinafter, the similarity between the received signal and the pilot signal is referred to as a cross-correlation spectrum. Specifically, by using the received signal and the pilot signal in whole or in part respectively, is called the cross-correlation spectrum, a spectrum consisting of a value C[m] indicating the similarity between the continuous portion starting from the m-th symbol of the received signal and the pilot signal. A basic example of such a cross-correlation spectrum is the cross-correlation.

Below, example embodiments of the present disclosure will be explained with reference to the drawings. Note that the one-directional arrows shown in each block diagram succinctly indicate the flow of information and do not exclude bidirectionality.

### First Example Embodiment

### [Explanation of Configuration]

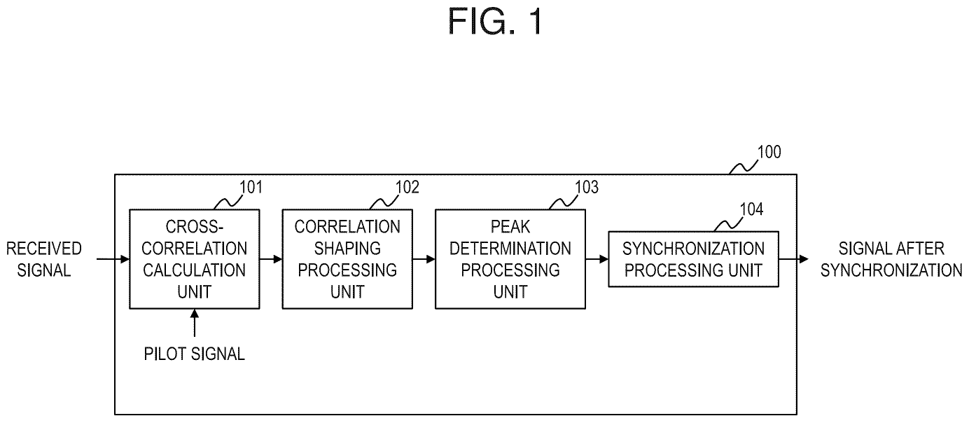

FIG. 1 is a block diagram showing a configuration example of a signal processing system according to a first example embodiment of the present disclosure. A signal processing system 100 of the first example embodiment includes a cross-correlation calculation unit 101, a correlation shaping processing unit 102, a peak determination processing unit 103, and a synchronization processing unit 104.

### [Explanation of Operation]

These units operate generally as follows.

The cross-correlation calculation unit 101 calculates a cross-correlation spectrum from the pilot signal and the received signal given as inputs. In this example embodiment, the received signal consists of multiple signals that have a temporal spread and are coupled to each other during propagation. Also, the pilot signal is a signal included in a portion of each received signal. As described above, the cross-correlation spectrum represents the similarity between the received signal and the pilot signal. The cross-correlation calculation unit 101 may calculate the cross-correlation spectrum by a known method.

The correlation shaping processing unit 102 receives the cross-correlation spectrum calculated by the cross-correlation calculation unit 101 as input, and performs arithmetic processing that shapes the cross-correlation spectrum so that its peak becomes relatively higher than the original peak. Such arithmetic processing is applied to the entire cross-correlation spectrum, resulting in a higher peak. Specific examples of this arithmetic processing will be explained later.

The peak determination processing unit 103 performs peak determination based on a threshold with respect to the cross-correlation spectrum after arithmetic processing by the correlation shaping processing unit 102. In other words, the peak determination processing unit 103 detects the peak of the cross-correlation spectrum that has undergone the arithmetic processing. If the peak detection is successful, the peak determination processing unit 103 outputs information on the position of the peak, and if the peak detection is unsuccessful, the peak determination processing unit 103 outputs information indicating the failure.

The synchronization processing unit 104 determines the position of the above-mentioned received signal corresponding to the above-mentioned pilot signal using the information on the position of the peak detected by the above-mentioned peak determination processing unit 103 as input, when the above-mentioned peak determination processing unit 103 successfully detects the peak. The synchronization processing unit 104 then uses the detected peak to perform time alignment, which aligns a point (hereafter referred to as the time origin) of synchronization between the pilot signal and the received signal.

The cross-correlation calculation unit 101, the correlation shaping processing unit 102, the peak determination processing unit 103, and the synchronization processing unit 104 may be implemented by a processor (for example, a CPU (Central Processing Unit) or a GPU (Graphics Processing Unit)) of a computer that operates according to a program (signal processing program). For example, the program may be stored in a storage unit (not shown) included in the signal processing system 100, and the processor may read the program and operate as the cross-correlation calculation unit 101, the correlation shaping processing unit 102, the peak determination processing unit 103, and the synchronization processing unit 104 in accordance with the program.

Alternatively, the functions of the cross-correlation calculation unit 101, the correlation shaping processing unit 102, the peak determination processing unit 103, and the synchronization processing unit 104 may be provided in a Saas (Software as a Service) format. Also, each of the cross-correlation calculation unit 101, the correlation shaping processing unit 102, the peak determination processing unit 103, and the synchronization processing unit 104 may be implemented by dedicated hardware.

Furthermore, some or all of the components in each device may be implemented by general-purpose or dedicated circuitry, processors, or combinations thereof. They may be configured by a single chip, or by multiple chips connected via a bus. Some or all of the components in each device may also be implemented by a combination of the above-mentioned circuitry and a program.

Where some or all of the components of the cross-correlation calculation unit 101, the correlation shaping processing unit 102, the peak determination processing unit 103, or the synchronization processing unit 104 are implemented by multiple information processing devices or circuits, these multiple devices or circuits may be centrally located or distributed. For example, the information processing devices or circuits may be connected via a communication network such as a client-server system or a cloud computing system.

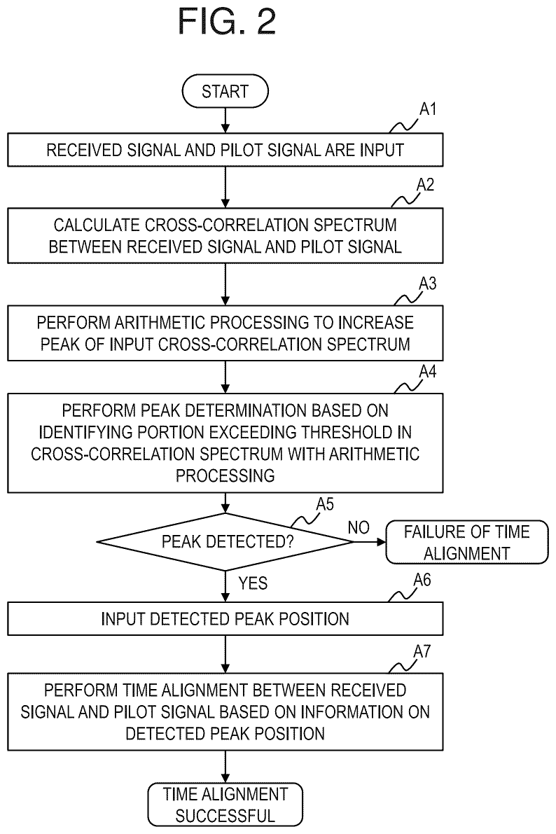

Next, the operation of this example embodiment will be explained. FIG. 2 is a flowchart showing an example of operation of the signal processing system according to this example embodiment.

First, the received signal and the pilot signal are input to the cross-correlation calculation unit 101 (step A1 in FIG. 2). Next, the cross-correlation calculation unit 101 calculates the cross-correlation spectrum between the received signal and the pilot signal, and inputs the result to the correlation shaping processing unit 102 (step A2).

The correlation shaping processing unit 102 performs arithmetic processing to increase the peak of the input cross-correlation spectrum, and then inputs the cross-correlation spectrum with arithmetic processing to the peak determination processing unit 103 (step A3). The peak determination processing unit 103 performs a peak determination based on identifying a portion exceeding a threshold in the cross-correlation spectrum with arithmetic processing (step A4).

If the peak determination processing unit 103 fails to detect a peak (No in step A5), time alignment fails and the process ends. On the other hand, if the peak determination processing unit 103 detects a peak (Yes in step A5), the peak determination processing unit 103 inputs the detected peak position to the synchronization processing unit 104 (step A6). Then, based on the information on the detected peak position, the synchronization processing unit 104 performs time alignment between the received signal and the pilot signal (step A7).

### [Explanation of Effects]

Next, the effects of this example embodiment will be explained. In this example embodiment, the correlation shaping processing unit 102 performs arithmetic processing on the cross-correlation spectrum calculated by the cross-correlation calculation unit 101 to make the peak relatively higher than the original peak, thereby increasing the success rate of peak determination. Accordingly, even under conditions where the cross-correlation peak becomes low, this configuration can suppress a decrease in the success rate of time alignment.

For example, when the length of the pilot signal is shortened, the peak height of the cross-correlation spectrum is reduced, making it difficult to determine an appropriate threshold. In contrast, in this example embodiment, the correlation shaping processing unit 102 applies arithmetic processing so that the peak of the cross-correlation spectrum becomes relatively higher than the original peak. Hence, it is possible to suppress a decrease in the success rate of time alignment. Moreover, by reducing the ratio of pilot signals within the overall signal, transmission capacity can be increased.

Additionally, because the correlation shaping processing unit 102 applies arithmetic processing to make the cross-correlation spectrum peak relatively higher with respect to the entire spectrum, even under conditions where the peak of the cross-correlation spectrum becomes low, the success rate of time alignment using the cross-correlation spectrum can be improved. This is because it becomes easier to determine an appropriate threshold to use for peak searching, which is necessary for time alignment.

### Second Example Embodiment

### [Explanation of Configuration]

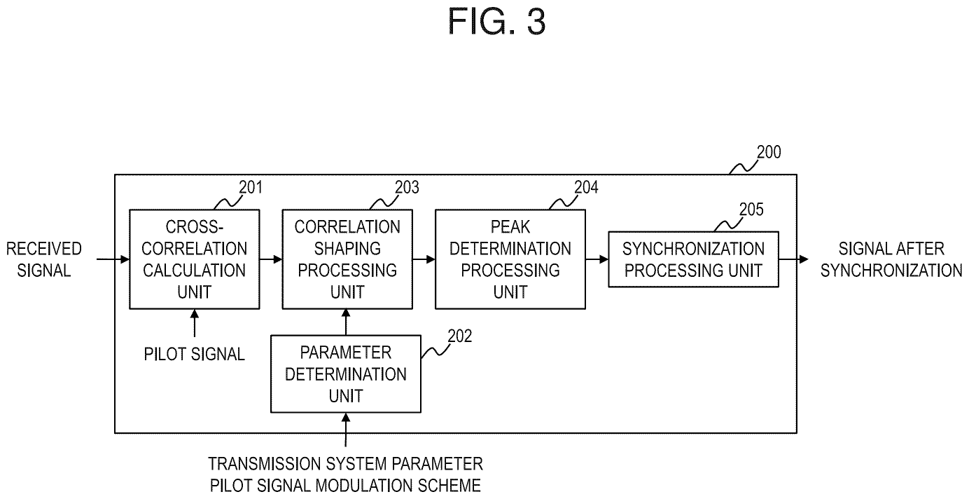

Next, a second example embodiment of the signal processing system of the present disclosure will be explained. FIG. 3 is a block diagram showing a configuration example of a signal processing system according to the second example embodiment of the present disclosure. A signal processing system 200 of the second example embodiment includes a cross-correlation calculation unit 201, a parameter determination unit 202, a correlation shaping processing unit 203, a peak determination processing unit 204, and a synchronization processing unit 205.

### [Explanation of Operation]

These units operate generally as follows. Note that the operations of the cross-correlation calculation unit 201, the peak determination processing unit 204, and the synchronization processing unit 205 are the same as those of the cross-correlation calculation unit 101, the peak determination processing unit 103, and the synchronization processing unit 104 in the first example embodiment.

The parameter determination unit 202 uses at least one of a parameter indicating the characteristics of a transmission system or information indicating the modulation scheme of the pilot signal to determine a parameter used for the arithmetic processing that shapes the peak of the cross-correlation spectrum (hereinafter referred to as a shaping parameter). Details of the shaping parameter will be explained later. The correlation shaping processing unit 203 then performs arithmetic processing to shape the peak using the shaping parameter.

The cross-correlation calculation unit 201, the parameter determination unit 202, the correlation shaping processing unit 203, the peak determination processing unit 204, and the synchronization processing unit 205 are implemented by a processor of a computer that operates according to a program (signal processing program).

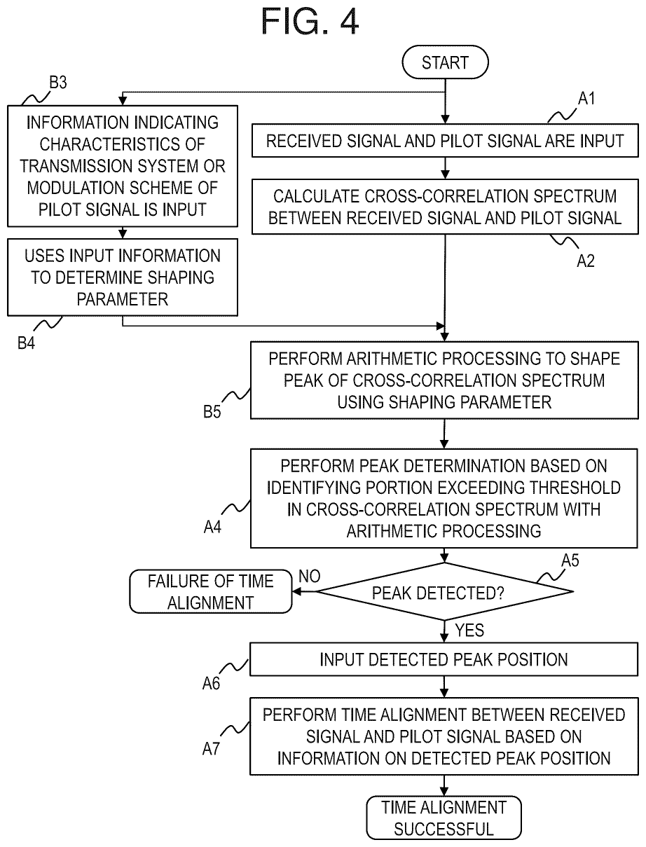

Next, the operation of this example embodiment will be explained. FIG. 4 is a flowchart showing an example of operation of the signal processing system according to this example embodiment. Processing up to the point where the cross-correlation spectrum is calculated is the same as steps A1 through A2 in FIG. 2.

In this example embodiment, information indicating characteristics of the transmission system or information indicating the modulation scheme of the pilot signal is input to the parameter determination unit 202 (step B3). Then, the parameter determination unit 202 uses the input information, such as the parameter indicating the characteristics of the transmission system or the information indicating the modulation scheme of the pilot signal, to determine a shaping parameter and inputs it to the correlation shaping processing unit 203 (step B4).

The correlation shaping processing unit 203 performs arithmetic processing to shape the peak of the cross-correlation spectrum input from the cross-correlation calculation unit 201, using the shaping parameter input from the parameter determination unit 202, and then inputs the cross-correlation spectrum after arithmetic processing to the peak determination processing unit 204 (step B5).

Subsequent processing, from peak determination to time alignment, is the same as steps A4 through A7 in FIG. 2.

### [Explanation of Effects]

Next, the effects of this example embodiment will be explained. In this example embodiment, the parameter determination unit 202 specifically determines the shaping parameter, used in the arithmetic processing that shapes the peak of the cross-correlation spectrum, from the parameter indicating the characteristics of the transmission path or the information indicating the modulation scheme of the pilot signal. Accordingly, in addition to the effects of the first example embodiment, it is possible to optimize the effect of the arithmetic processing performed on the cross-correlation spectrum for various transmission systems.

### Third Example Embodiment

### [Explanation of Configuration]

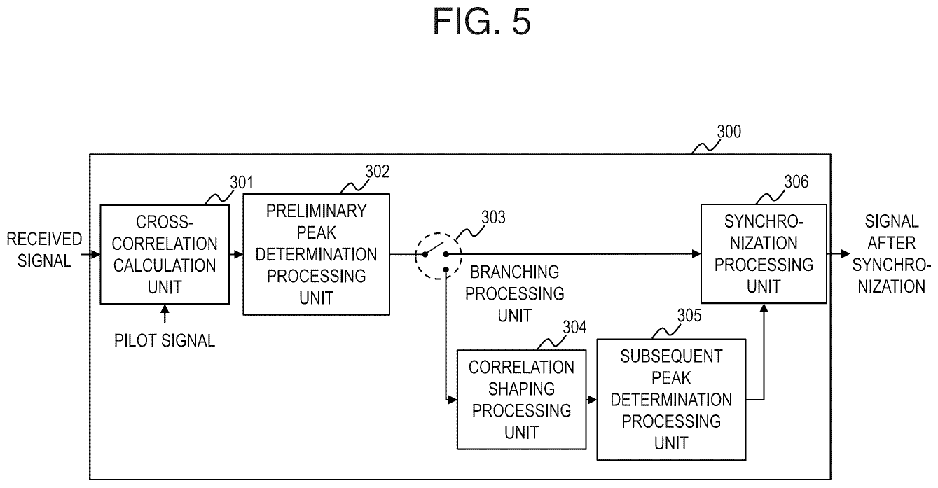

Next, a third example embodiment of the signal processing system of the present disclosure will be explained. FIG. 5 is a block diagram showing a configuration example of a signal processing system according to the third example embodiment of the present disclosure. A signal processing system 300 of the third example embodiment includes a cross-correlation calculation unit 301, a preliminary peak determination processing unit 302, a branching processing unit 303, a correlation shaping processing unit 304, a subsequent peak determination processing unit 305, and a synchronization processing unit 306.

### [Explanation of Operation]

These units operate generally as follows. Note that the operations of the cross-correlation calculation unit 301, the correlation shaping processing unit 304, and the synchronization processing unit 306 are the same as those of the cross-correlation calculation unit 101, the correlation shaping processing unit 102, and the synchronization processing unit 104 in the first example embodiment.

Also, the methods used by the preliminary peak determination processing unit 302 and

the subsequent peak determination processing unit 305 to determine peaks are the same as the method used by the peak determination processing unit 103 in the first example embodiment. However, the cross-correlation spectrum for which the peak is detected differs between the preliminary peak determination processing unit 302 and the subsequent peak determination processing unit 305. Specifically, the preliminary peak determination processing unit 302 detects the peak of the cross-correlation spectrum before arithmetic processing is performed, while the subsequent peak determination processing unit 305 detects the peak of the cross-correlation spectrum after arithmetic processing is performed.

The branching processing unit 303 determines subsequent processing based on whether or not the peak detection performed by the preliminary peak determination processing unit 302 succeeds. In other words, the branching processing unit 303 causes the correlation shaping processing unit 304 and the subsequent peak determination processing unit 305 to execute processing if no peak is detected in the cross-correlation spectrum.

The cross-correlation calculation unit 301, the preliminary peak determination processing unit 302, the branching processing unit 303, the correlation shaping processing unit 304, the subsequent peak determination processing unit 305, and the synchronization processing unit 306 are implemented by a processor of a computer that operates according to a program (signal processing program).

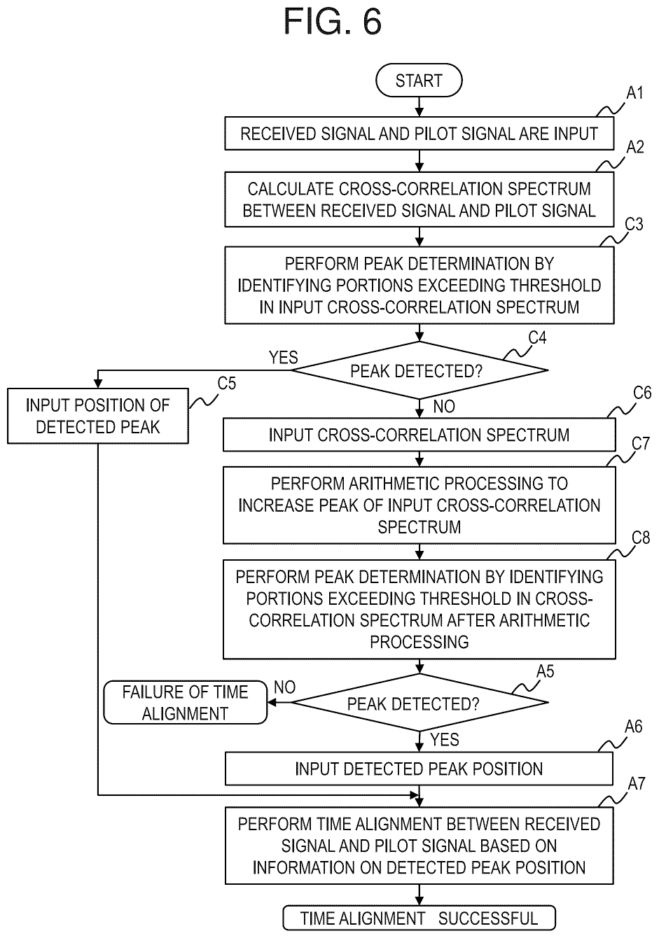

Next, the operation of this example embodiment will be explained. FIG. 6 is a flowchart showing an example of operation of the signal processing system according to this example embodiment.

Processing up to the point where the cross-correlation spectrum is calculated is the same as steps A1 through A2 in FIG. 2.

The preliminary peak determination processing unit 302 performs a peak determination by identifying portions exceeding a threshold in the input cross-correlation spectrum (step C3).

If a peak is detected by the preliminary peak determination processing unit 302 (Yes in step C4), the process moves to step C5, and if a peak is not detected (No in step C4), the process moves to step C6. Note that this branching processing is determined by the branching processing unit 303.

That is, if a peak is detected, the preliminary peak determination processing unit 302 inputs the position of the detected peak to the synchronization processing unit 306 and proceeds to step A7 (step C5). On the other hand, if no peak is detected, the preliminary peak determination processing unit 302 inputs the cross-correlation spectrum to the correlation shaping processing unit 304 (step C6).

The correlation shaping processing unit 304 performs arithmetic processing to increase the peak of the input cross-correlation spectrum and inputs the cross-correlation spectrum after arithmetic processing to the subsequent peak determination processing unit 305 (step C7). The subsequent peak determination processing unit 305 performs a peak determination by identifying portions exceeding a threshold in the cross-correlation spectrum after arithmetic processing (step C8).

Subsequent processing, from the result of peak determination to synchronization, is the same as steps A5 through A7 in FIG. 2.

### [Explanation of Effects]

Next, the effects of this example embodiment will be explained. In this example embodiment, the preliminary peak determination processing unit 302 first performs a peak determination before the arithmetic processing that increases the cross-correlation spectrum peak relatively is performed, and if a peak is detected, synchronization processing is performed as is. Therefore, in addition to the effects of the first example embodiment, when the arithmetic processing is unnecessary, it can be omitted, thereby reducing unneeded computation time.

Further, the signal processing system 300 of this example embodiment may include the parameter determination unit 202 from the second example embodiment. With that configuration, the effects described in the second example embodiment can also be achieved.

### Fourth Example Embodiment

### [Explanation of Configuration]

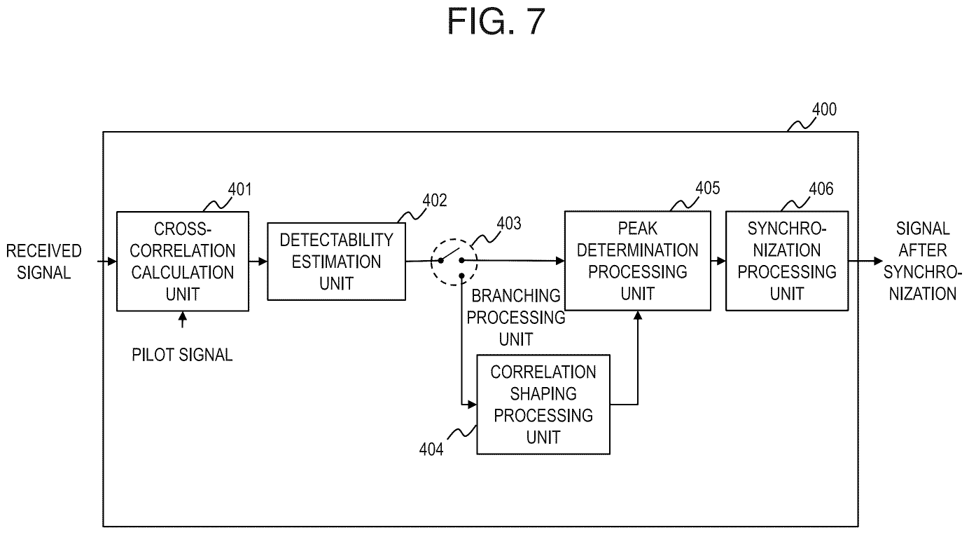

Next, a fourth example embodiment of the signal processing system of the present disclosure will be explained. FIG. 7 is a block diagram showing a configuration example of a signal processing system according to the fourth example embodiment of the present disclosure. A signal processing system 400 of the fourth example embodiment includes a cross-correlation calculation unit 401, a detectability estimation unit 402, a branching processing unit 403, a correlation shaping processing unit 404, a peak determination processing unit 405, and a synchronization processing unit 406.

### [Explanation of Operation]

These units operate generally as follows. Note that the operations of the cross-correlation calculation unit 401, the correlation shaping processing unit 404, the peak determination processing unit 405, and the synchronization processing unit 406 are the same as those of cross-correlation calculation unit 101, the correlation shaping processing unit 102, the peak determination processing unit 103, and the synchronization processing unit 104 in the first example embodiment.

The detectability estimation unit 402 uses an index that distinguishes the magnitude of the peak in the cross-correlation spectrum from that of non-peak portions to estimate the likelihood of successful peak detection. Details of the index and the method of using the index to estimate this likelihood will be explained later.

The branching processing unit 403 determines subsequent processing based on the likelihood of the successful peak detection estimated by detectability estimation unit 402. That is, the branching processing unit 403 causes the correlation shaping processing unit 404 to perform arithmetic processing (namely, the arithmetic processing that makes the cross-correlation spectrum peak relatively higher than the original peak) if the likelihood of successful peak detection is lower than a predetermined standard.

The cross-correlation calculation unit 401, the detectability estimation unit 402, the branching processing unit 403, the correlation shaping processing unit 404, the peak determination processing unit 405, and the synchronization processing unit 406 are implemented by a processor of a computer that operates according to a program (signal processing program).

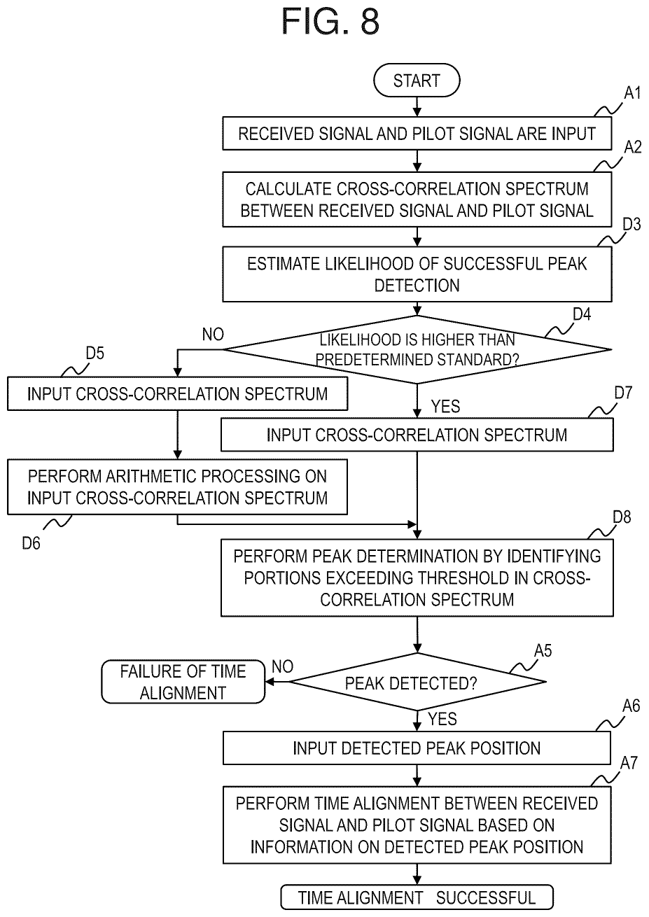

Next, the operation of this example embodiment will be explained. FIG. 8 is a flowchart showing an example of operation of the signal processing system according to this example embodiment.

Processing up to the point where the cross-correlation spectrum is calculated is the same as steps A1 through A2 in FIG. 2.

The detectability estimation unit 402 estimates the likelihood of successful peak detection, using an index that distinguishes the magnitude of the peak in the cross-correlation spectrum from that of non-peak portions (step D3).

If the likelihood of success is not higher than the predetermined standard (No in step D4), the process moves to step D5, and if it is higher (Yes in step D4), the process moves to step D7. Note that this branching processing is determined by the branching processing unit 403.

That is, if the likelihood of success is not higher than the predetermined standard, the detectability estimation unit 402 inputs the cross-correlation spectrum to the correlation shaping processing unit 404 (step D5). Then, the correlation shaping processing unit 404 performs arithmetic processing on the input cross-correlation spectrum, inputs the cross-correlation spectrum after arithmetic processing to the peak determination processing unit 405, and proceeds to step D8 (step D6). On the other hand, if the likelihood of success is higher than the predetermined standard, the detectability estimation unit 402 inputs the cross-correlation spectrum to the peak determination processing unit 405 (step D7).

The peak determination processing unit 405 performs a peak determination by identifying portions exceeding a threshold in the cross-correlation spectrum (step D8). Subsequent processing, synchronization process according to the results of the peak determination, is the same as steps A5 through A7 in FIG. 2.

### [Explanation of Effects]

Next, the effects of this example embodiment will be explained. In this example embodiment, the detectability estimation unit 402 estimates the likelihood of successful peak detection, and the correlation shaping processing unit 404 performs arithmetic processing when that likelihood is low. Therefore, in addition to the effects of the first example embodiment, it is possible to reduce unnecessary arithmetic processing. Furthermore, in this example embodiment, the peak determination processing unit 405 also shares a processing unit that performs peak determination on the cross-correlation spectrum and the cross-correlation spectrum after arithmetic processing. Hence, it is possible to reduce unnecessary signal processing blocks.

Further, the signal processing system 400 of this example embodiment may include the parameter determination unit 202 in the second example embodiment. With that configuration, the effects described in the second example embodiment can also be achieved.

Note that the signal processing systems 100 to 400 described above may be used for time alignment of received signals in spatial-mode multiplexed optical signal communication using a multi-core fiber, time alignment of received signals in propagation-mode multiplexed optical signal communication using a multi-mode fiber, or time alignment of received signals in polarization-multiplexed optical signal communication using a single-mode fiber.

### Specific Example

Next, a specific example is used to explain the operation of the example embodiments of the present disclosure.

First, a specific example of the first example embodiment will be explained.

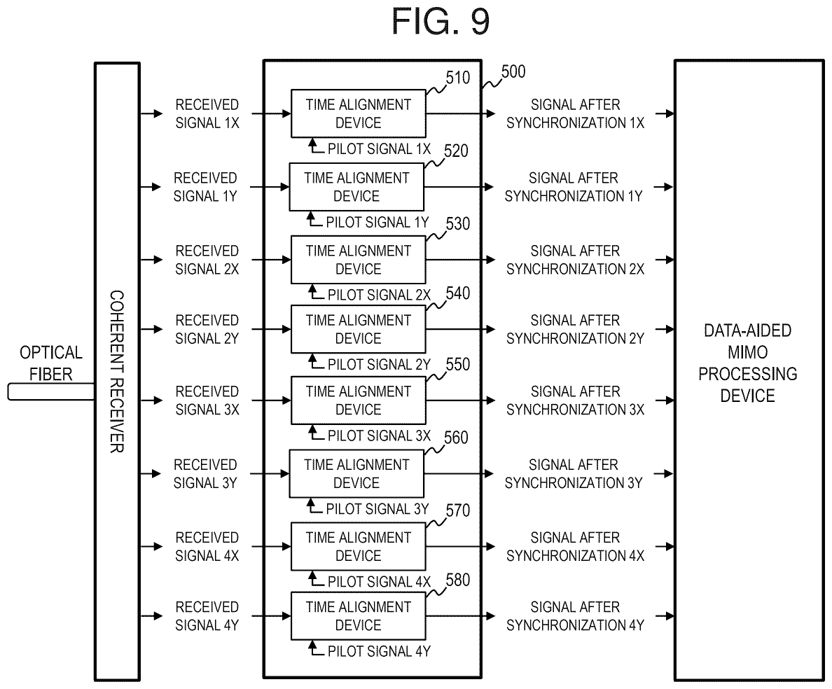

In this specific example, the signal processing device 500 is used in the front stage of a data-aided MIMO processing device for optical signal communication that uses an optical fiber having multiple propagation modes. FIG. 9 is an explanatory diagram showing a configuration example using the signal processing device 500.

The signal processing device 500 is used, for example, in optical signal communication employing a coupled 4-core MCF with four spatial modes (a total of 4×2=8 modes) each subjected to polarization multiplexing, as illustrated in FIG. 9. As the optical fiber having multiple propagation modes, an MCF with a different number of cores may be used, or an MMF for mode division multiplexing (MDM) optical signal communication may be used.

The signal processing device 500 may also be used in optical signal communication employing polarization division multiplexing (PDM) in a single-mode fiber (SMF), or in optical signal communication adopting a multiplexing scheme that combines those methods.

The signal processing device 500 includes time alignment devices 510 to 580. Each time alignment device 510 to 580 corresponds to the signal processing system 100 in the first example embodiment. In other words, the signal processing device 500 can be regarded as a device in which multiple signal processing systems 100 of the first example embodiment are arranged in parallel.

The time alignment device 510 processes received signal 1X corresponding to the x-polarization of core 1 in the MCF received by a coherent receiver. The time alignment device 520 processes received signal 1Y corresponding to the y-polarization of core 1. The time alignment device 530 processes received signal 2X corresponding to the x-polarization of core 2. The time alignment device 540 processes received signal 2Y corresponding to the y-polarization of core 2. The time alignment device 550 processes received signal 3X corresponding to the x-polarization of core 3. The time alignment device 560 processes received signal 3Y corresponding to the y-polarization of core 3. The time alignment device 570 processes received signal 4X corresponding to the x-polarization of core 4. The time alignment device 580 processes received signal 4Y corresponding to the y-polarization of core 4.

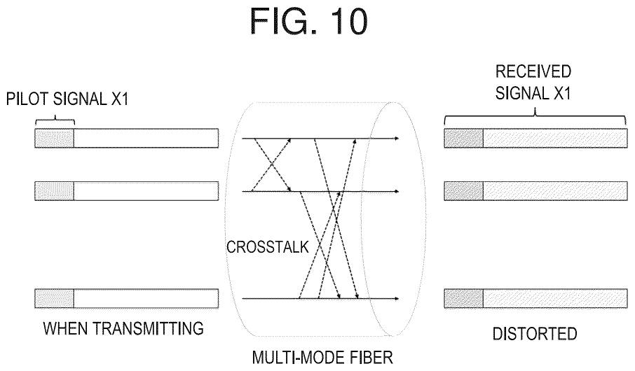

FIG. 10 is an explanatory diagram showing an example of a received signal. As illustrated in FIG. 10, each received signal is the result of inter-modal crosstalk and distortion during propagation of the transmitted signal, which contains the pilot signal as part of it. In this specific example, the modulation scheme of the transmitted signal and the pilot signal is assumed to be quadrature phase shift keying (QPSK). However, other modulation schemes may also be used. The pilot signal included in each transmitted signal may be different or the same.

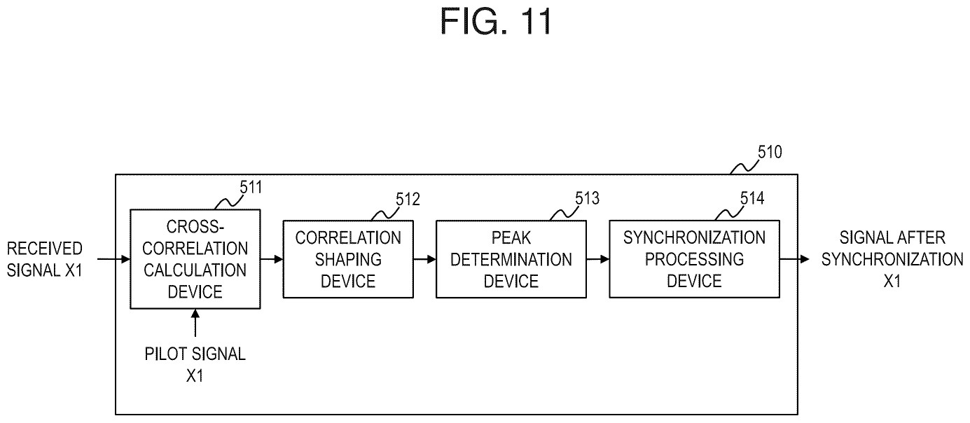

FIG. 11 is a block diagram showing a configuration example of the time alignment device 510. The time alignment device 510 includes a cross-correlation calculation device 511, a correlation shaping device 512, a peak determination device 513, and a synchronization processing device 514. Here, each device may be implemented entirely or partly by an FPGA (Field Programmable Gate Array) or an ASIC (Application Specific Integration Circuit), or by a program executed on a computer or other computing machine.

The cross-correlation calculation device 511, the correlation shaping device 512, the peak determination device 513, and the synchronization processing device 514 in this specific example respectively correspond to the cross-correlation calculation unit 101, the correlation shaping processing unit 102, the peak determination processing unit 103, and the synchronization processing unit 104 in the first example embodiment. With this configuration, time alignment device 510 operates generally as follows.

The cross-correlation calculation device 511 calculates the cross-correlation spectrum C[m], for example, using Equation 1 illustrated below. Here, the length of the received signal is N symbols, and m is a natural number ranging from 0 to N−1. Also, x[j] (j=0,1, . . . , N−1) is the received signal, and y[k] (k=0,1, . . . , N−1) is the pilot signal.

However, in practice, the length of pilot signal y[k] is M (M<N), and y[k]=0 for k>M−1. Also, the cross-correlation calculation device 511 may calculate the cross-correlation spectrum using only part of the pilot signal rather than its entirety. In that case, let M′ (<M) be the length of the portion of the pilot signal used to calculate the cross-correlation spectrum, and assume y[k]=0 for k>M′−1.

$$\begin{matrix}[ Math . 1 ] & \\ C [ m ] = \vert {\sum }_{i = 0}^{N - m - 1} x [ i + m ] {y}^{*} [ i ] \vert & ( Equation 1 )\end{matrix}$$

In addition, the cross-correlation calculation device 511 may use a normalized version of C[m] as the cross-correlation spectrum.

The correlation shaping device 512 performs arithmetic processing on the cross-correlation spectrum calculated by the cross-correlation calculation device 511 so that the peak of the cross-correlation spectrum becomes relatively higher than the original peak. Specific examples of this arithmetic processing are explained below.

First, a first example of the arithmetic processing is explained. When the optical signal-to-noise ratio (OSNR) is sufficiently high, two QPSK-modulated signals are uncorrelated, and all symbols of the pilot signal appear in the calculation of the cross-correlation spectrum, that is, assume m<N−M−1. In this case, the component excluding the absolute value of C[m] follows a two-dimensional normal distribution on the complex plane, and its standard deviation σ₁ is represented by Equation 2 illustrated below. Here, it is assumed that both the pilot signal and the received signal are normalized by power.

$$\begin{matrix}[ Math . 2 ] & \\ {σ}_{1} = \sqrt{M} & ( Equation 2 )\end{matrix}$$

By dividing the cross-correlation spectrum by σ₁, it can be normalized. When the two signals used to calculate the cross-correlation spectrum are uncorrelated, the value shown in Equation 3 below, which is the square of the portion of the cross-correlation spectrum for m<N−M−1, is a random variable following a chi-squared distribution with 2 degrees of freedom. Because the peak used for time alignment is not the value of the cross-correlation spectrum calculated by uncorrelated signals, it does not follow this chi-squared distribution.

Moreover, due to SMD, only the area around the peak of the cross-correlation spectrum does not behave as a random variable following a chi-squared distribution. Hence, the correlation shaping device 512 may take a moving average of the square of the cross-correlation spectrum, with an appropriate window width w₁, according to Equation 4 illustrated below. That is, the correlation shaping device 512 may shape the cross-correlation spectrum peak by performing arithmetic processing to calculate the moving average of the square of the normalized cross-correlation spectrum. Through this arithmetic processing, it is possible to obtain a cross-correlation spectrum C₁[m] that has undergone arithmetic processing and exhibits a peak relatively higher than the original peak.

Additionally, the correlation shaping device 512 may experimentally determine σ₁ using a portion of the received signal known not to contain the pilot signal. If the effect of containing the pilot signal can be ignored, the correlation shaping device 512 may experimentally determine σ₁ by using the entire received signal.

$$\begin{matrix}[ Math . 3 ] & \\ {C}^{′} [ m ] = {( \frac{C [ m ]}{{σ}_{1}} )}^{2} & ( Equation 3 ) \\ [ Math . 4 ] & \\ {C}_{1} [ m ] = \frac{1}{2 {w}_{1} + 1} {\sum }_{i = m - {w}_{1}}^{m + {w}_{1}} {C}^{′} [ i ] & ( Equation 4 )\end{matrix}$$

Next, a second example of the arithmetic processing is explained. In the cross-correlation spectrum C₁[m] obtained by the arithmetic processing explained in the first example, the portion where the received signal and the pilot signal are uncorrelated is centered around 2, which is the mean of the chi-squared distribution with 2 degrees of freedom. The correlation shaping device 512 may subtract this constant value according to Equation 5 illustrated below and output the result as cross-correlation spectrum C₂[m] that has undergone arithmetic processing. In other words, the correlation shaping device 512 may shape the cross-correlation spectrum peak by performing arithmetic processing to subtract a constant value from the moving average of the square of the normalized cross-correlation spectrum.

$$\begin{matrix}[ Math . 5 ] & \\ {C}_{2} [ m ] = {C}_{1} [ m ] - 2 & ( Equation 5 )\end{matrix}$$

Next, a third example of the arithmetic processing is explained. In the cross-correlation spectrum that has undergone the arithmetic processing explained in the second example, the standard deviation follows a normal distribution with a width σ₂ expressed by Equation 6 illustrated below, according to the central limit theorem. Therefore, the correlation shaping device 512 normalizes the cross-correlation spectrum C₂[m] that has undergone the arithmetic processing explained in the second example by dividing by σ₂. Then, the correlation shaping device 512 squares the portion for m<N−M−1, that is, calculates the value C₂′[m] shown in Equation 7 below, and takes a moving average with an appropriate window width w₂ according to Equation 8 illustrated below.

That is, the correlation shaping device 512 shapes the cross-correlation spectrum peak by performing arithmetic processing to calculate the moving average of the squares of the cross-correlation spectrum normalized for the result of subtracting a constant value from the moving average of the squares of the normalized cross-correlation spectrum. Through this arithmetic processing, it is possible to obtain a cross-correlation spectrum C₃[m], which has undergone arithmetic processing such that components other than the peak used for time alignment are suppressed.

Additionally, the correlation shaping device 512 may experimentally determine σ₂ using a portion of the received signal known not to contain the pilot signal. If the effect of containing the pilot signal can be ignored, the correlation shaping device 512 may experimentally determine σ₂ by using the entire received signal.

$$\begin{matrix}[ Math . 6 ] & \\ {σ}_{2} = 2 / \sqrt{2 {w}_{1} + 1} & ( Equation 6 ) \\ [ Math . 7 ] & \\ {C}_{2}^{′} [ m ] = {( \frac{{C}_{2}}{{σ}_{2}} )}^{2} & ( Equation 7 ) \\ [ Math . 8 ] & \\ {C}_{3} [ m ] = \frac{1}{2 {w}_{2} + 1} {\sum }_{i = m - {w}_{2}}^{m + {w}_{2}} {C}_{2}^{′} [ i ] & ( Equation 8 )\end{matrix}$$

These arithmetic processes are effective because the cross-correlation spectrum peak broadens due to the SMD of the optical fiber. Likewise, for example, even in cases where the signal has a temporal spread due to factors other than SMD, such as polarization mode dispersion (PMD), these arithmetic processes are also effective.

The method of arithmetic processing is not limited to the above examples. For example, it may be performed based on statistical quantities of the cross-correlation spectrum, or arbitrary processing may be applied. In any case, it suffices if the arithmetic processing makes the cross-correlation spectrum peak relatively higher than the original peak.

The peak determination device 513 performs peak determination based on a peak determination threshold 1 for the cross-correlation spectrum that has undergone such arithmetic processing. Specifically, among the cross-correlation spectrum that has undergone arithmetic processing, the peak determination device 513 regards any symbol m whose value exceeds the peak determination threshold 1 as the start of the portion in the received signal corresponding to the pilot signal. If no symbol m exceeds the peak determination threshold 1, time alignment fails.

If multiple symbols m whose values exceed the peak determination threshold 1 exist, the peak determination device 513 selects one appropriate symbol m. For example, the peak determination device 513 may select the symbol m that has the largest value in the cross-correlation spectrum after arithmetic processing. The peak determination device 513 then inputs the value of that symbol m, identified as the start of the portion in the received signal corresponding to the pilot signal, to the synchronization processing device 514.

The peak determination device 513 may use, for example, a decision condition for peak detection that the cross-correlation spectrum exceeds a constant multiple of the average value. That is, the peak determination device 513 may detect the cross-correlation spectrum peak by using, as a threshold, a value obtained by multiplying the average of the cross-correlation spectrum after arithmetic processing by a constant.

For example, let μ be the average of the cross-correlation spectrum after arithmetic processing, calculated by Equation 9 illustrated below. In that case, the peak determination device 513 may use a value of μ multiplied by a constant (e.g. 5 μ) as the peak determination threshold 1.

Moreover, the peak determination threshold 1 may be determined based on an index that combines other statistical quantities (mean, variance, median, maximum value, etc.) of the cross-correlation spectrum that has undergone arithmetic processing, or it may be an arbitrarily chosen value that can distinguish the peak from other parts.

$$\begin{matrix}[ Math . 9 ] & \\ μ = \frac{1}{N} {\sum }_{í = 0}^{N - 1} {C}_{1} [ i ] & ( Equation 9 )\end{matrix}$$

The synchronization processing device 514, based on the information about the start of the portion in the received signal corresponding to the pilot signal detected by the peak determination device 513, performs time alignment by aligning the time origin so that the portion of the received signal corresponding to the pilot signal is placed at the start. Here, the time alignment process may be performed by digital signal processing, or by using delay lines or other methods for delaying signals.

Note that the configuration of the time alignment devices 520 to 580 is the same as that of the time alignment device 510. Specifically, if each time alignment device is denoted as 5N0 with respect to the time alignment device 510 (where N ranges from 2 to 8), then the received signal 1 may be replaced with received signal n, pilot signal 1 with pilot signal n, and peak determination threshold 1 with peak determination threshold n, respectively. By time-aligning each received signal, subsequent MIMO processing can be performed.

In this specific example, a case of using an MCF for optical communication is described. However, the signal processing device 500 may also be used for MIMO processing in PDM using an SMF or MDM using an MMF.

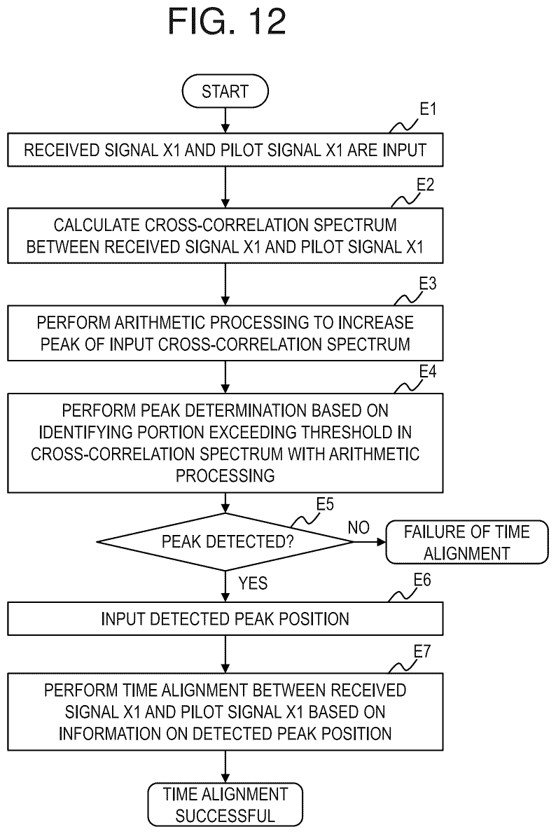

FIG. 12 is a flowchart showing an example of operation of the time alignment device in this specific example. Because the processes from step E1 to step E7 in the flowchart shown in FIG. 12 are a more concrete version of the processes from step A1 to step A7 in the flowchart shown in FIG. 2, detailed explanation is omitted.

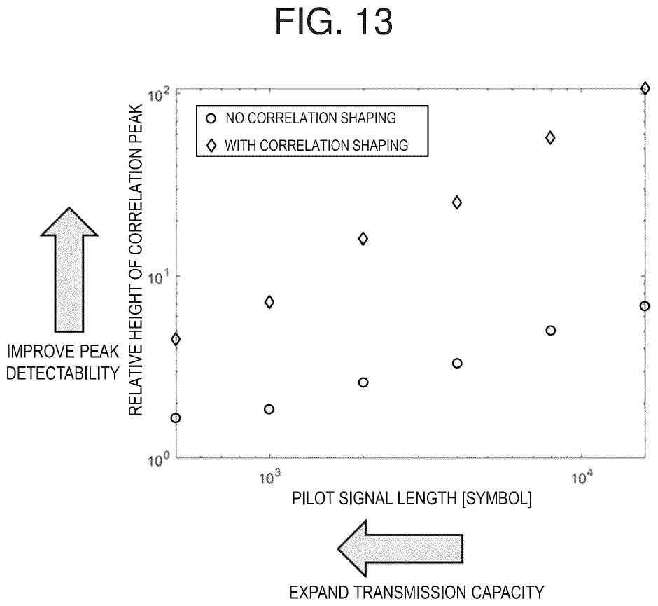

FIG. 13 is an explanatory diagram showing an example of changes in the success rate of peak determination. Specifically, FIG. 13 shows how the possibility of peak determination changes before and after shaping by the correlation shaping device. As shown in FIG. 13, the arithmetic processing in the correlation shaping device makes the possibility of detecting the peak of the cross-correlation spectrum higher for the cross-correlation spectrum after arithmetic processing (corresponding to C₂[m] mentioned above). Thus, even when using a shorter pilot signal, information transmission is feasible.

Next, a specific example of the second example embodiment will be explained.

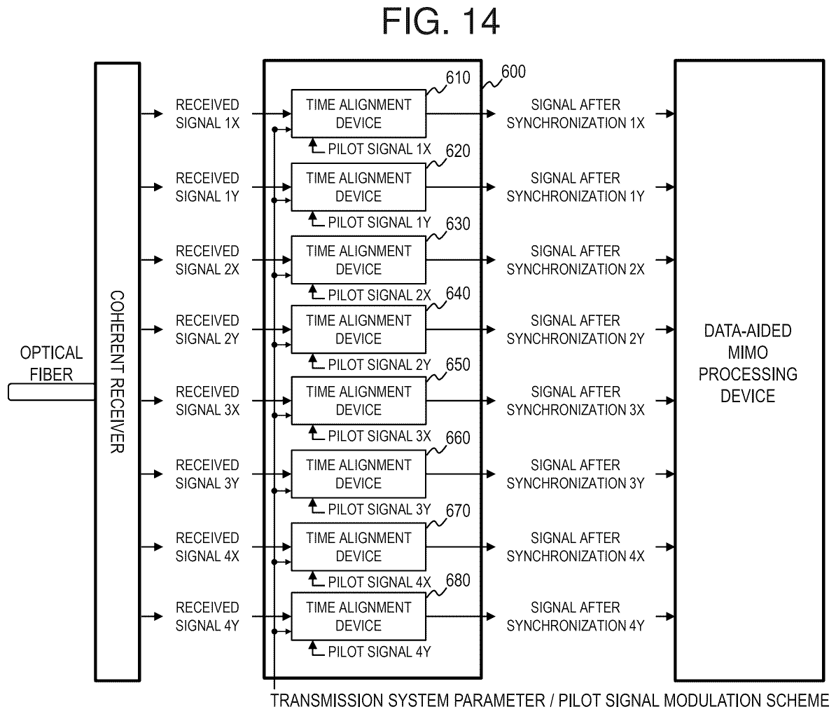

In this specific example, the signal processing device 600 is used in the front stage of a data-aided MIMO processing device for optical signal communication that uses an optical fiber having multiple propagation modes. FIG. 14 is an explanatory diagram showing a configuration example using the signal processing device 600.

The signal processing device 600 is used, for example, in optical signal communication employing a coupled 4-core MCF with four spatial modes (a total of 4×2=8 modes), each subjected to polarization multiplexing, as illustrated in FIG. 14. As the optical fiber having multiple propagation modes, an MCF with a different number of cores may be used, or an MMF for MDM optical signal communication may be used.

The signal processing device 600 may also be used in optical signal communication employing PDM in an SMF, or in optical signal communication adopting a multiplexing scheme that combines those methods.

The signal processing device 600 includes time alignment devices 610 to 680. Each time alignment device 610 to 680 corresponds to the signal processing system 200 in the second example embodiment. In other words, the signal processing device 600 can be regarded as a device in which multiple signal processing systems 200 of the second example embodiment are arranged in parallel. Such a configuration, which includes multiple signal processing systems 200, can be referred to as a multi-signal processing system.

The time alignment device 610 processes received signal 1X corresponding to the x-polarization of core 1 in the MCF received by a coherent receiver. The time alignment device 620 processes received signal 1Y corresponding to the y-polarization of core 1. The time alignment device 630 processes received signal 2X corresponding to the x-polarization of core 2. The time alignment device 640 processes received signal 2Y corresponding to the y-polarization of core 2. The time alignment device 650 processes received signal 3X corresponding to the x- polarization of core 3. The time alignment device 660 processes received signal 3Y corresponding to the y-polarization of core 3. The time alignment device 670 processes received signal 4X corresponding to the x-polarization of core 4. The time alignment device 680 processes received signal 4Y corresponding to the y-polarization of core 4.

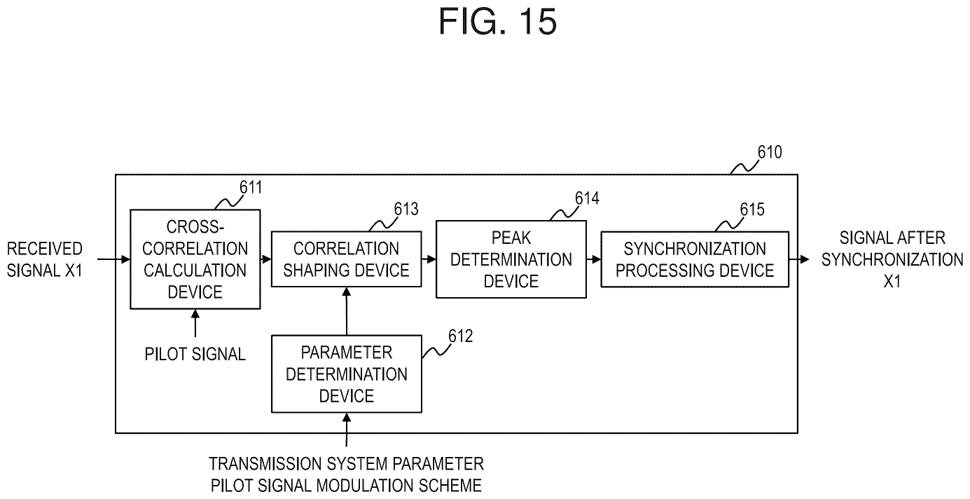

FIG. 15 is a block diagram showing a configuration example of the time alignment device 610. The time alignment device 610 includes a cross-correlation calculation device 611, a parameter determination device 612, a correlation shaping device 613, a peak determination device 614, and a synchronization processing device 615.

The cross-correlation calculation device 611, the parameter determination device 612, the correlation shaping device 613, the peak determination device 614, and the synchronization processing device 615 in this specific example respectively correspond to the cross-correlation calculation unit 201, the parameter determination unit 202, the correlation shaping processing unit 203, the peak determination processing unit 204, and the synchronization processing unit 205 in the second example embodiment. With this configuration, the time alignment device 610 operates generally as follows.

The cross-correlation calculation device 611, the peak determination device 614, and the synchronization processing device 615 operate in the same manner as the cross-correlation calculation device 511, the peak determination device 513, and the synchronization processing device 514 in the specific example of the first example embodiment explained above.

The parameter determination device 612 uses, for example, SMD (σSMD)), which is one of the parameters characterizing the MCF, along with transmission distance L and sample rate Rₛ, to determine the moving-average window w₁, which is one of the shaping parameters used by the correlation shaping device 613, based on Equation 10 illustrated below. In Equation 10, the parentheses indicate the greatest integer less than or equal to that value. Also, the cross-correlation calculation device 611 may determine, for example, the type of arithmetic processing performed by the correlation shaping device 613 according to the modulation scheme of the pilot signal.

$$\begin{matrix}[ Math . 10 ] & \\ {w}_{1} = ⌊ {σ}_{SDM} \cdot \sqrt{L} \cdot {R}_{s} ⌋ & ( Equation 10 )\end{matrix}$$

The correlation shaping device 613 operates in the same manner as the correlation shaping device 512 in the specific example of the first example embodiment described above. However, the value of w₁ used in the arithmetic processing of the first example embodiment's specific example is replaced by the value determined by the parameter determination device 612.

The configuration of the time alignment devices 620 to 680 is the same as that of the time alignment device 610. By time-aligning each received signal, subsequent MIMO processing can be performed.

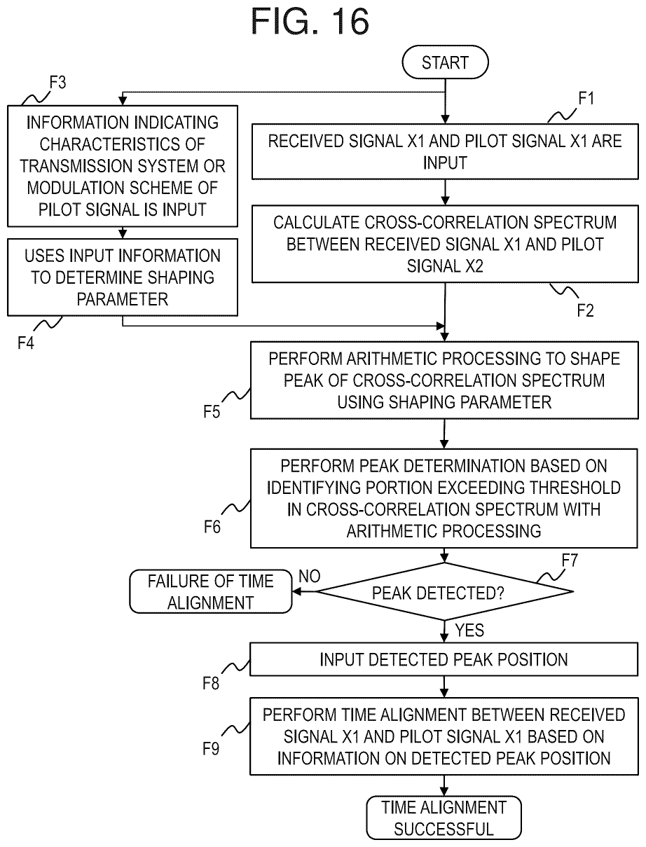

FIG. 16 is a flowchart showing an example of operation of the time alignment device in

this specific example. Because the processes from step F1 to step F9 in the flowchart shown in FIG. 16 are a more concrete version of the processes from step A1 to step A7 in the flowchart shown in FIG. 4, detailed explanation is omitted.

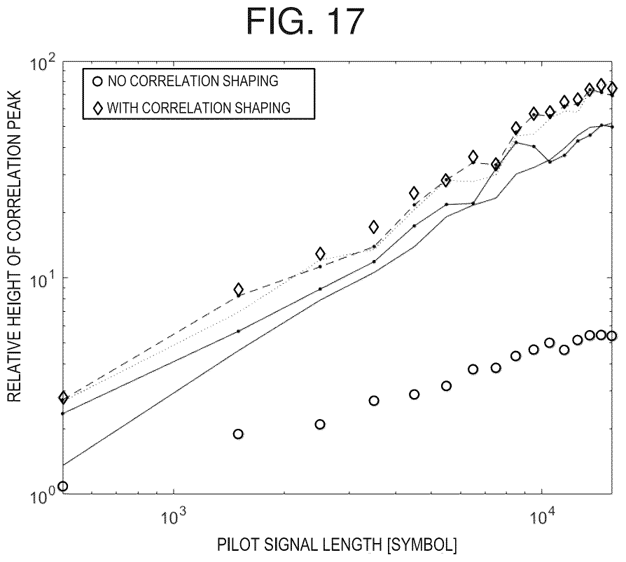

FIG. 17 is an explanatory diagram showing an example of changes in the success rate of peak determination when the shaping parameter is varied. Specifically, FIG. 17 shows how the possibility of peak determination changes when the value of w₁ used for shaping the cross-correlation spectrum is changed. Each line in FIG. 17 represents the detectability of the cross-correlation spectrum peak after arithmetic processing, given that w₁ is assigned arbitrarily. In addition, the diamond symbol (⋄) in FIG. 17 represents the detectability of the cross-correlation spectrum peak when w₁ is determined according to Equation 10. As shown in FIG. 17, w₁ calculated by Equation 10 provides higher peak detectability compared to an arbitrarily chosen w₁.

Next, a specific example of the third example embodiment will be explained.

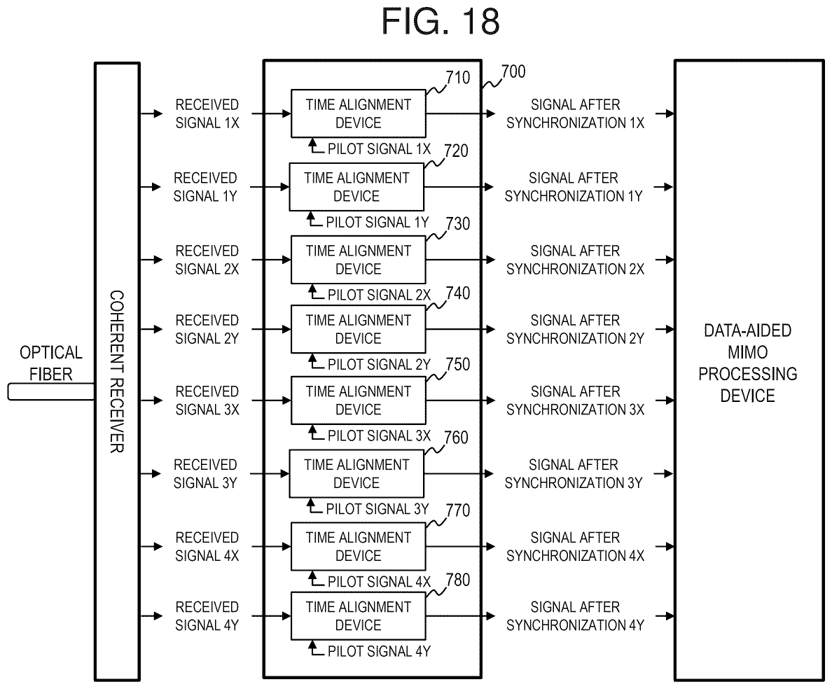

In this specific example, the signal processing device 700 is used in the front stage of a data-aided MIMO processing device for optical signal communication that uses an optical fiber having multiple propagation modes. FIG. 18 is an explanatory diagram showing a configuration example using the signal processing device 700.

The signal processing device 700 is used, for example, in optical signal communication employing a coupled 4-core MCF with four spatial modes (a total of 4×2=8 modes), each subjected to polarization multiplexing, as illustrated in FIG. 18. As the optical fiber having multiple propagation modes, an MCF with a different number of cores may be used, or an MMF for MDM optical signal communication may be used.

The signal processing device 700 may also be used in optical signal communication employing PDM in an SMF, or in optical signal communication adopting a multiplexing scheme that combines those methods.

The signal processing device 700 includes time alignment devices 710 to 780. Each time alignment device 710 to 780 corresponds to the signal processing system 300 in the third example embodiment. In other words, the signal processing device 700 can be regarded as a device in which multiple signal processing systems 300 of the third example embodiment are arranged in parallel. Such a configuration, which includes multiple signal processing systems 300, can be referred to as a multi-signal processing system.

The time alignment device 710 processes received signal 1X corresponding to the x-polarization of core 1 in the MCF received by a coherent receiver. The time alignment device 720 processes received signal 1Y corresponding to the y-polarization of core 1. The time alignment device 730 processes received signal 2X corresponding to the x-polarization of core 2. The time alignment device 740 processes received signal 2Y corresponding to the y-polarization of core 2. The time alignment device 750 processes received signal 3X corresponding to the x-polarization of core 3. The time alignment device 760 processes received signal 3Y corresponding to the y-polarization of core 3. The time alignment device 770 processes received signal 4X corresponding to the x-polarization of core 4. The time alignment device 780 processes received signal 4Y corresponding to the y-polarization of core 4.

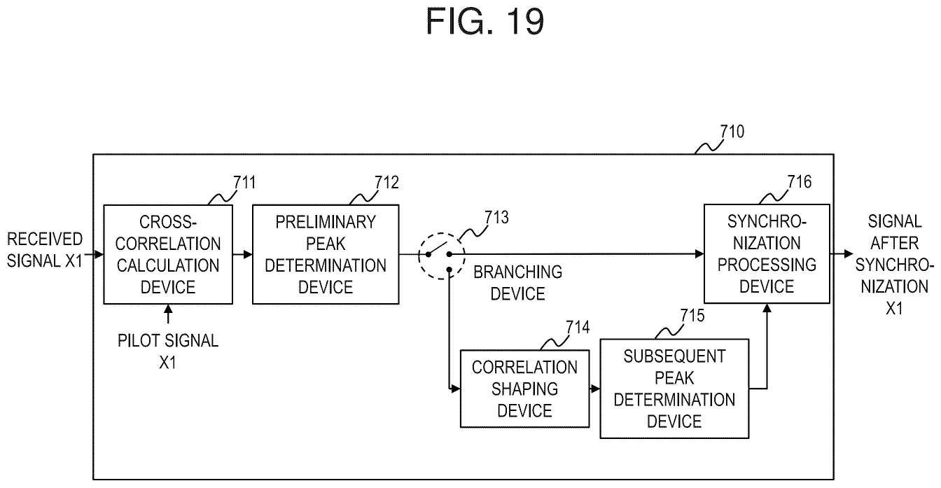

FIG. 19 is a block diagram showing a configuration example of time alignment device 710. The time alignment device 710 includes a cross-correlation calculation device 711, a preliminary peak determination device 712, a branching device 713, a correlation shaping device 714, a subsequent peak determination device 715, and a synchronization processing device 716.

The cross-correlation calculation device 711, the preliminary peak determination device 712, the branching device 713, the correlation shaping device 714, the subsequent peak determination device 715, and the synchronization processing device 716 in this specific example respectively correspond to the cross-correlation calculation unit 301, the preliminary peak determination processing unit 302, the branching processing unit 303, the correlation shaping processing unit 304, the subsequent peak determination processing unit 305, and the synchronization processing unit 306 in the third example embodiment. With this configuration, the time alignment device 710 operates generally as follows.

The cross-correlation calculation device 711, the correlation shaping device 714, and the subsequent peak determination device 715 operate in the same manner as the cross-correlation calculation device 511, the correlation shaping device 512, and the peak determination device 513 in the specific example of the first example embodiment explained above.

The preliminary peak determination device 712 performs a peak determination based on a preliminary peak determination threshold 1 with respect to the cross-correlation spectrum calculated by the cross-correlation calculation device 711. Specifically, among the values in the cross-correlation spectrum, the preliminary peak determination device 712 regards any symbol m whose value exceeds the preliminary peak determination threshold 1 as the start of the portion in the received signal corresponding to the pilot signal, and inputs the fact that peak determination was successful to the branching device 713. If no symbol m exceeds the preliminary peak determination threshold 1, the preliminary peak determination device 712 inputs the fact that peak determination was failed to the branching device 713.

If multiple symbols m whose values exceed the preliminary peak determination threshold 1 exist, the preliminary peak determination device 712 selects one appropriate symbol m. For example, the preliminary peak determination device 712 may select the symbol m that has the largest value in the cross-correlation spectrum.

The preliminary peak determination device 712 may use, for example, a decision condition for peak detection that the cross-correlation spectrum exceeds a constant multiple of the average value. That is, the preliminary peak determination device 712 may detect the cross-correlation spectrum peak by using, as a threshold, a value obtained by multiplying the average of the cross-correlation spectrum by a constant.

For example, let μ be the average of the cross-correlation spectrum, calculated by Equation 11 illustrated below. In that case, the preliminary peak determination device 712 may use a value of μ multiplied by a constant (e.g. 5 μ) as the preliminary peak determination threshold 1.

Moreover, the preliminary peak determination threshold 1 may be determined based on an index that combines other statistical quantities of the cross-correlation spectrum (such as mean, variance, median, maximum value, etc.), or it may be an arbitrarily chosen value that can distinguish the peak from other parts.

$$\begin{matrix}[ Math . 11 ] & \\ μ = \frac{1}{N} {\sum }_{i = 0}^{N - 1} C [ i ] & ( Equation 11 )\end{matrix}$$

If the preliminary peak determination device 712 successfully detects a peak, the synchronization processing device 716 performs time alignment so that the portion in the received signal corresponding to the pilot signal is placed at the start, based on symbol m input from the branching device 713. If the preliminary peak determination device 712 fails to detect a peak, the synchronization processing device 716 performs time alignment so that the portion in the received signal corresponding to the pilot signal is placed at the start, based on symbol m input from the subsequent peak determination device 715. Here, the time alignment process may be performed by digital signal processing, or by using a delay line or other means of delaying signals.

Note that the configuration of the time alignment devices 720 to 780 is the same as that of the time alignment device 710. Specifically, if each time alignment device is denoted as 7N0 with respect to the time alignment device 710 (where N ranges from 2 to 8), then the preliminary peak determination threshold 1 may be replaced by preliminary peak determination threshold N. By time-aligning each received signal, subsequent MIMO processing can be performed.

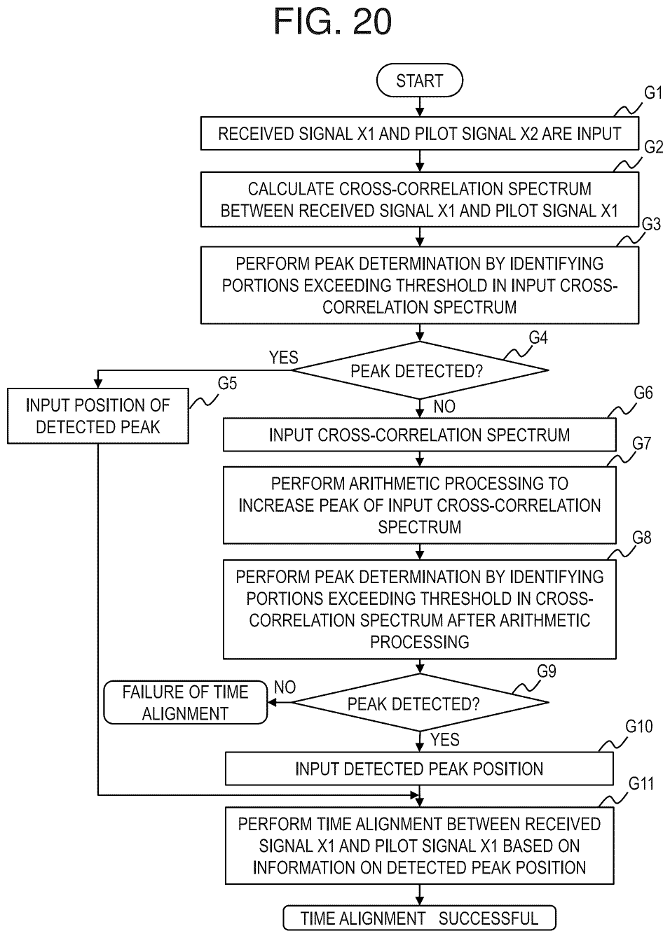

FIG. 20 is a flowchart showing an example of operation of the time alignment device in this specific example. Because the processes from step G1 to step G11 in the flowchart shown in FIG. 20 are a more concrete version of the processes from step A1 to step A7 in the flowchart shown in FIG. 6, detailed explanation is omitted.

Next, a specific example of the fourth example embodiment will be explained.

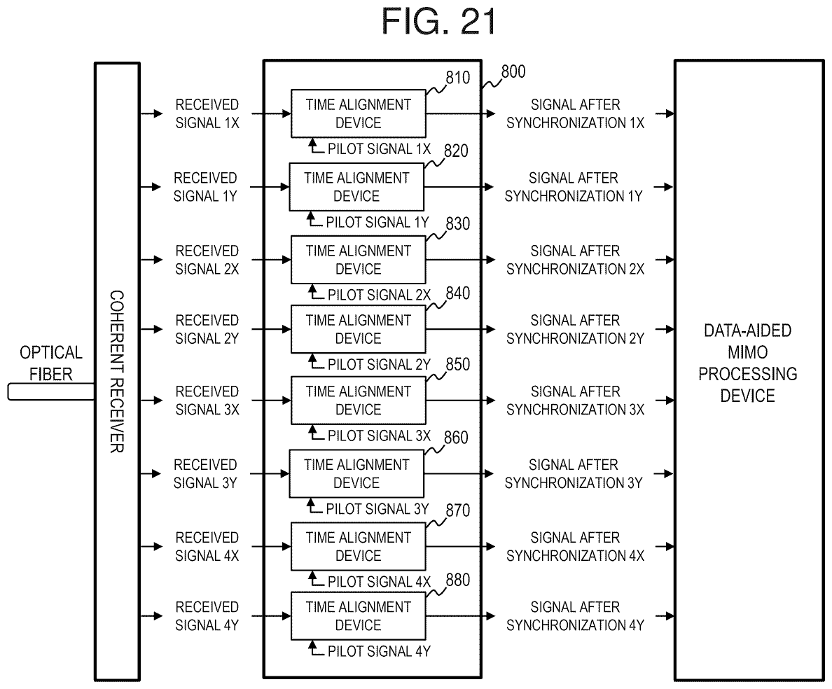

In this specific example, the signal processing device 800 is used in the front stage of a data-aided MIMO processing device for optical signal communication that uses an optical fiber having multiple propagation modes. FIG. 21 is an explanatory diagram showing a configuration example using signal processing device 800.

The signal processing device 800 is used, for example, in optical signal communication employing a coupled 4-core MCF with four spatial modes (a total of 4×2=8 modes), each subjected to polarization multiplexing, as illustrated in FIG. 21. As the optical fiber having multiple propagation modes, an MCF with a different number of cores may be used, or an MMF for MDM optical signal communication may be used.

The signal processing device 800 may also be used in optical signal communication employing PDM in an SMF, or in optical signal communication adopting a multiplexing scheme that combines those methods.

The signal processing device 800 includes time alignment devices 810 to 880. Each time alignment device 810 to 880 corresponds to the signal processing system 400 in the fourth example embodiment. In other words, the signal processing device 800 can be regarded as a device in which multiple signal processing systems 400 of the fourth example embodiment are arranged in parallel. Such a configuration, which includes multiple signal processing systems 400, can be referred to as a multi-signal processing system.

The time alignment device 810 processes received signal 1X corresponding to the X-polarization of core 1 in the MCF received by a coherent receiver. The time alignment device 820 processes received signal 1Y corresponding to the Y-polarization of core 1. The time alignment device 830 processes received signal 2X corresponding to the X-polarization of core 2. The time alignment device 840 processes received signal 2Y corresponding to the Y-polarization of core 2. The time alignment device 850 processes received signal 3X corresponding to the X-polarization of core 3. The time alignment device 860 processes received signal 3Y corresponding to the Y-polarization of core 3. The time alignment device 870 processes received signal 4X corresponding to the X-polarization of core 4. The time alignment device 880 processes received signal 4Y corresponding to the Y-polarization of core 4.

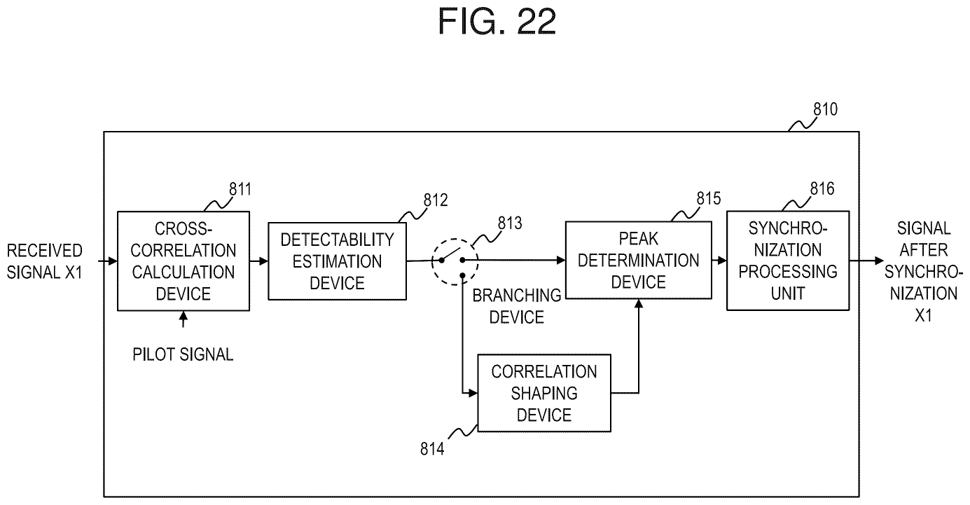

FIG. 22 is a block diagram showing a configuration example of time alignment device 810. The time alignment device 810 includes a cross-correlation calculation device 811, a detectability estimation device 812, a branching device 813, a correlation shaping device 814, a peak determination device 815, and a synchronization processing device 816.

The cross-correlation calculation device 811, the detectability estimation device 812, the branching device 813, the correlation shaping device 814, the peak determination device 815, and the synchronization processing device 816 in this specific example respectively correspond to the cross-correlation calculation unit 401, the detectability estimation unit 402, the branching processing unit 403, the correlation shaping processing unit 404, the peak determination processing unit 405, and the synchronization processing unit 406 in the fourth example embodiment. With this configuration, the time alignment device 810 operates generally as follows.

The cross-correlation calculation device 811 and the synchronization processing device 816 operate in the same manner as the cross-correlation calculation device 511 and the synchronization processing device 514 in the specific example of the first example embodiment explained above.

The detectability estimation device 812 estimates the likelihood of successful peak detection using an index that distinguishes the magnitude of the peak in the cross-correlation spectrum, calculated by the cross-correlation calculation device 811, from that of non-peak portions. This index may, for example, be an arbitrary value obtained empirically. Alternatively, the index may be determined based on statistical quantities such as the average, maximum value, or minimum value of the calculated cross-correlation spectrum. Examples of methods for estimating detectability using such statistical quantities are explained below.

First, a first example for estimating detectability is explained.

The detectability estimation device 812 calculates the maximum value Cₘₐₓ of the cross-correlation spectrum. Next, the detectability estimation device 812 calculates the maximum value Cₘₐₓ₂ of the cross-correlation spectrum after removing the surrounding range of Cₘₐₓ. The surrounding range may be set in advance. For example, the detectability estimation device 812 determines the maximum value of C[n] (where n is an integer that satisfies |n−m|>10) as Cₘₐₓ₂ using a symbol m such that C[m]=Cₘₐₓ.

Then, the detectability estimation device 812 calculates Cₘₐₓ/Cₘₐₓ₂. That is, the detectability estimation device 812 estimates the likelihood of successful peak detection based on the ratio of the maximum value of the cross-correlation spectrum to the maximum value of the cross-correlation spectrum calculated after removing a predetermined range around that maximum.

Cₘₐₓ/Cₘₐₓ₂ indicates how high the cross-correlation spectrum peak is compared to its surroundings. Therefore, the detectability estimation device 812 may determine that there is a high probability that a peak will be detected in the cross-correlation spectrum if this value exceeds a value sufficiently larger than 1 (for example, 2). Next, a second example for estimating detectability is explained.

The detectability estimation device 812 uses the average value u of the cross-correlation spectrum calculated by Equation 11 described above, and calculates (Cₘₐₓ−μ)/(Cₘₐₓ₂−μ). That is, the detectability estimation device 812 estimates the likelihood of successful peak detection based on the ratio of the difference between the maximum value of the cross-correlation spectrum and its average value, to the difference between the maximum value of the cross-correlation spectrum obtained after removing a predetermined range around that maximum and the same average value.

This value indicates how high the cross-correlation spectrum peak is compared to its surroundings, and it also becomes larger even when μ is relatively large. Therefore, the detectability estimation device 812 may determine that there is a high probability that a peak will be detected in the cross-correlation spectrum if this value exceeds a value sufficiently larger than 1 (for example, 2).

Next, a third example for estimating detectability is explained.

The detectability estimation device 812 uses the standard deviation σ_{C} of the cross-correlation spectrum, calculated by Equation 12 illustrated below, and calculates (Cₘₐₓ−μ)/σ_{C}. That is, the detectability estimation device 812 estimates the likelihood of successful peak detection based on the ratio of the difference between the maximum value of the cross-correlation spectrum and its average value, to the standard deviation of the cross-correlation spectrum.

This value indicates how large the cross-correlation spectrum peak is relative to the overall spread of the cross-correlation spectrum. The detectability estimation device 812 may determine that there is a high probability that a peak will be detected in the cross-correlation spectrum if this value exceeds a value sufficiently large (for example, 5).

$$\begin{matrix}[ Math . 12 ] & \\ {σ}_{C} = \sqrt{\frac{1}{N} {\sum }_{i = 0}^{N - 1} {( C [ i ] - μ )}^{2}} & ( Equation 12 )\end{matrix}$$

The branching device 813 determines that if the detectability estimation device 812 determines that the likelihood of a successful peak detection is high, no arithmetic processing is needed to increase the cross-correlation spectrum peak relative to its surroundings, and inputs the cross-correlation spectrum to the peak determination device 815. If it is determined that the likelihood of a successful peak detection is not high, the branching device 813 determines that arithmetic processing is needed to make the cross-correlation spectrum peak relatively higher, and inputs the cross-correlation spectrum to the correlation shaping device 814.

When the branching device 813 determines that arithmetic processing is needed, the correlation shaping device 814 operates in the same manner as the correlation shaping device 512 in the specific example of the first example embodiment. The parameters used by the correlation shaping device 814 may be determined arbitrarily or may be determined by a device that operates in the same manner as the parameter determination device 612 in the specific example of the second example embodiment.

The peak determination device 815 performs a peak determination using peak determination threshold 1a on the cross-correlation spectrum calculated by the cross-correlation calculation device 811 if the detectability estimation device 812 determines that the likelihood of a successful peak detection is high. On the other hand, if it is determined that the likelihood of a successful peak detection is not high, the peak determination device 815 performs a peak determination using peak determination threshold 1b on the cross-correlation spectrum that has undergone arithmetic processing by the correlation shaping device 814.

Here, the peak determination threshold 1a and the peak determination threshold 1b may each be determined by different methods, or the same method may be used by treating the cross-correlation spectrum and the processed cross-correlation spectrum equivalently. Among the cross-correlation spectrum or the processed cross-correlation spectrum, any symbol m whose value exceeds the peak determination threshold 1a or the peak determination threshold 1b is regarded as the start of the portion in the received signal corresponding to the pilot signal, and the result is input to the synchronization processing device 816.

Specifically, the peak determination device 815 regards any symbol m in the cross-correlation spectrum whose value exceeds peak the determination threshold 1a as the start of the portion in the received signal corresponding to the pilot signal, and inputs that information to the synchronization processing device 816. Similarly, among the arithmetic processed cross- correlation spectrum, the peak determination device 815 regards any symbol m whose value exceeds the peak determination threshold 1b as the start of the portion in the received signal corresponding to the pilot signal, and inputs that information to the synchronization processing device 816.

If no symbol m whose value exceeds the peak determination threshold 1a or the peak determination threshold 1b exist, synchronization processing fails. If multiple symbols m whose value exceeds the peak determination threshold 1a or the peak determination threshold 1b exist, the peak determination device 815 selects one appropriate symbol m. For example, the peak determination device 815 may select the symbol m that has the largest value among the cross-correlation spectrum or the processed cross-correlation spectrum.

note that the configuration of the time alignment devices 820 to 880 is the same as that of the time alignment device 810. Specifically, if each time alignment device is denoted as 8N0 with respect to time alignment device 810 (where N ranges from 2 to 8), then the peak determination threshold 1a can be replaced by peak determination threshold Na, and the peak determination threshold 1b by peak determination threshold Nb. By time-aligning each received signal, subsequent MIMO processing can be performed.

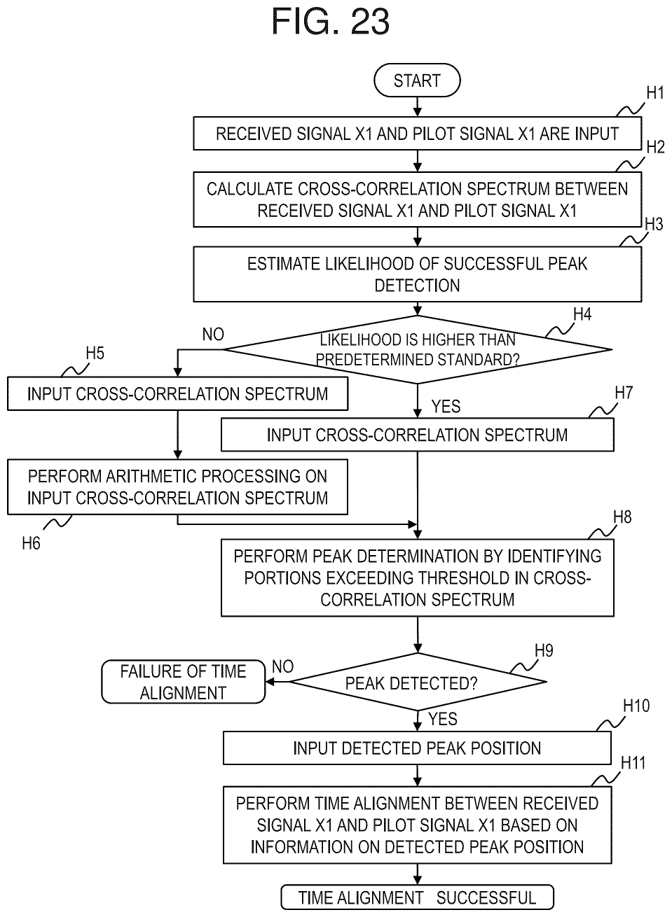

FIG. 23 is a flowchart showing an example of operation of the time alignment device in this specific example. Because the processes from step H1 to step H11 in the flowchart shown in FIG. 23 are a more concrete version of the processes from step A1 to step A7 in the flowchart shown in FIG. 8, detailed explanation is omitted.

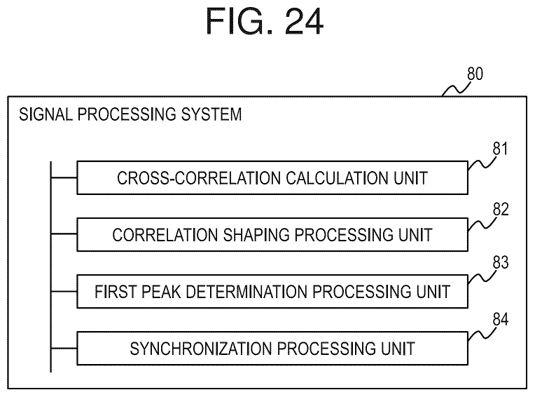

Next, an overview of the present disclosure will be explained. FIG. 24 is a block diagram showing an overview of a signal processing system according to the present disclosure. A signal processing system 80 (for example, signal processing system 100) according to the present disclosure includes: a cross-correlation calculation unit 81 (for example, cross-correlation calculation unit 101) configured to calculate a cross-correlation spectrum representing similarity between each of multiple received signals, which have a temporal spread and are coupled to each other during propagation, and a pilot signal included in part of each of the received signals; a correlation shaping processing unit 82 (for example, correlation shaping processing unit 102) configured to perform arithmetic processing that shapes the peak of the cross-correlation spectrum so that it becomes higher than an original peak; a first peak determination processing unit 83 (for example, peak determination processing unit 103) configured to detect the peak of the cross-correlation spectrum after arithmetic processing; and a synchronization processing unit 84 (for example, synchronization processing unit 104) configured to perform time alignment that aligns a time origin to synchronize the pilot signal and the received signals by using the detected peak.

With such a configuration, it is possible to suppress a decrease in the success rate of time alignment even under conditions where the cross-correlation peak becomes low.

In addition, the signal processing system 80 (for example, signal processing system 200) may include a parameter determination unit (for example, parameter determination unit 202) configured to determine a shaping parameter, which is a parameter used in the arithmetic processing for shaping the peak of the cross-correlation spectrum, by using at least one of a parameter indicating the characteristics of a transmission system or information indicating a modulation scheme of the pilot signal. The correlation shaping processing unit 82 may then perform arithmetic processing that shapes the peak using the shaping parameter.

Specifically, the parameter determination unit may determine the shaping parameter by using the product of spatial mode dispersion, transmission distance, and sample rate.

Further, the first peak determination processing unit 83 may detect the peak of the cross-correlation spectrum by using, as a threshold for peak detection, a value obtained by multiplying the average value of the cross-correlation spectrum after arithmetic processing by a constant.

In addition, the signal processing system 80 (for example, signal processing system 300) may include a second peak determination processing unit (for example, preliminary peak determination processing unit 302) configured to detect the peak of the cross-correlation spectrum before arithmetic processing is performed. The correlation shaping processing unit 82 may perform the arithmetic processing that shapes the peak of the cross-correlation spectrum, if the second peak determination processing unit fails to detect a peak. Also, the first peak determination processing unit (for example, subsequent peak determination processing unit 305) may detect the peak of the cross-correlation spectrum after arithmetic processing.

Specifically, the second peak determination processing unit may detect the peak of the cross-correlation spectrum by using, as a threshold for peak detection, a value obtained by multiplying the average value of the cross-correlation spectrum by a constant.

Also, the signal processing system 80 (for example, signal processing system 400) may include a detectability estimation unit (for example, detectability estimation unit 402) configured to estimate the likelihood of successful peak detection by using an index that distinguishes the magnitude of the peak in the cross-correlation spectrum from that of non-peak portions. The correlation shaping processing unit 82 may perform arithmetic processing that shapes the peak of the cross-correlation spectrum, if the likelihood is lower than a predetermined standard.

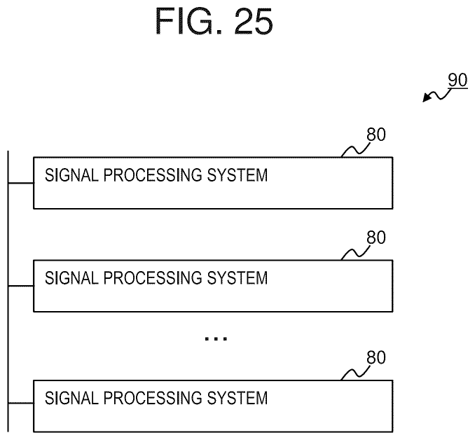

FIG. 25 is a block diagram showing an overview of a multi-signal processing system according to the present disclosure. A multi-signal processing system 90 according to the present disclosure is configured such that the signal processing system 80 illustrated in FIG. 24 is arranged in parallel, and at least one of a parameter indicating characteristics of a transmission system or information indicating a modulation scheme of the pilot signal is input to each signal processing system.

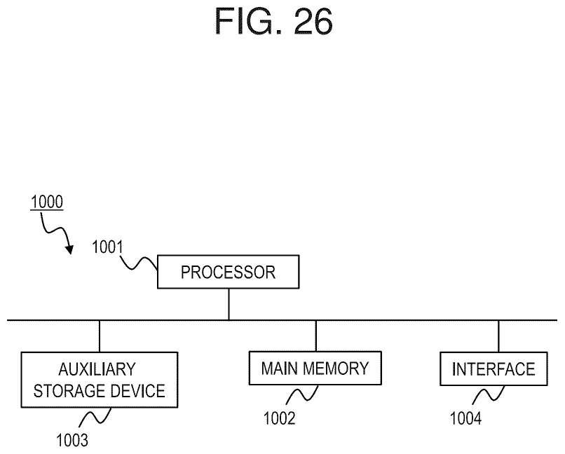

FIG. 26 is a schematic block diagram showing a configuration of a computer according to at least one example embodiment. The computer 1000 includes a processor 1001, a main storage device 1002, an auxiliary storage device 1003, and an interface 1004.

The signal processing system 80 described above is implemented on computer 1000. The operations of the respective processing units described above are stored, in the form of a program (signal processing program), in auxiliary storage device 1003. The processor 1001 reads out the program from the auxiliary storage device 1003, deploys it in the main storage device 1002, and executes the aforementioned processing according to the program.

In at least one example embodiment, the auxiliary storage device 1003 is an example of a non-transitory tangible medium. Other examples of non-transitory tangible media include magnetic disks, magneto-optical disks, CD-ROM (Compact Disc Read-only Memory), DVD-ROM (Read-only Memory), semiconductor memory, and so forth, all of which can be connected via the interface 1004. When the program is delivered to the computer 1000 via a communication line, the computer 1000 that receives the delivery may deploy that program in the main storage device 1002 and execute the aforementioned processing.

Moreover, the program may be intended to implement a part of the aforementioned functions. Furthermore, the program may be a so-called difference file (difference program) that implements the aforementioned functions in combination with another program that is already stored in the auxiliary storage device 1003.

Some or all of the above example embodiments may also be described as follows, but are not limited thereto.

(Supplementary Note 1) A signal processing system comprising:
a cross-correlation calculation unit configured to calculate a cross-correlation spectrum representing similarity between each of multiple received signals, which have a temporal spread and are coupled to each other during propagation, and a pilot signal included in part of each of the received signals;
a correlation shaping processing unit configured to perform arithmetic processing that shapes the peak of the cross-correlation spectrum so that it becomes higher than an original peak;
a first peak determination processing unit configured to detect the peak of the cross-correlation spectrum after the arithmetic processing; and
a synchronization processing unit configured to perform time alignment that aligns a time origin to synchronize the pilot signal and the received signals by using the detected peak.

(Supplementary Note 2) The signal processing system according to Supplementary Note 1, further comprising
a parameter determination unit configured to determine a shaping parameter, which is a parameter used in the arithmetic processing of the cross-correlation spectrum, by using at least one of a parameter indicating characteristics of a transmission system or information indicating a modulation scheme of the pilot signal,
wherein the correlation shaping processing unit performs the arithmetic processing by using the shaping parameter.

(Supplementary Note 3) The signal processing system according to Supplementary Note 2, wherein the parameter determination unit determines the shaping parameter by using the product of spatial mode dispersion, transmission distance, and sample rate. (Supplementary Note 4) The signal processing system according to any one of

Supplementary Notes 1 to 3, wherein the first peak determination processing unit detects the peak of the cross-correlation spectrum by using, as a threshold for peak detection, a value obtained by multiplying the average value of the cross-correlation spectrum after arithmetic processing by a constant.

(Supplementary Note 5) The signal processing system according to any one of Supplementary Notes 1 to 4, further comprising
a second peak determination processing unit configured to detect the peak of the cross-correlation spectrum before arithmetic processing is performed,
wherein the correlation shaping processing unit performs the arithmetic processing on the cross-correlation spectrum if the second peak determination processing unit fails to detect a peak, and
the first peak determination processing unit detects the peak of the cross-correlation spectrum after the arithmetic processing.

(Supplementary Note 6) The signal processing system according to Supplementary Note 5, wherein the second peak determination processing unit detects the peak of the cross-correlation spectrum by using, as a threshold for peak detection, a value obtained by multiplying the average value of the cross-correlation spectrum by a constant.

(Supplementary Note 7) The signal processing system according to any one of Supplementary Notes 1 to 3, further comprising
a detectability estimation unit configured to estimate the likelihood of successful peak detection by using an index that distinguishes the magnitude of the peak in the cross-correlation spectrum from that of non-peak portions,
wherein the correlation shaping processing unit performs arithmetic processing on the cross-correlation spectrum if the likelihood is lower than a predetermined standard.

(Supplementary Note 8) The signal processing system according to Supplementary Note 7, wherein the detectability estimation unit estimates the likelihood of successful peak detection based on the ratio of the maximum value of the cross-correlation spectrum to the maximum value of the cross-correlation spectrum obtained after removing a predetermined range around the maximum value.

(Supplementary Note 9) The signal processing system according to Supplementary Note 7, wherein the detectability estimation unit estimates the likelihood of successful peak detection based on the ratio of (i) the difference between the maximum value of the cross-correlation spectrum and its average value to (ii) the difference between the maximum value of the cross-correlation spectrum obtained after removing a predetermined range around that maximum value and the average value.

(Supplementary Note 10) The signal processing system according to Supplementary Note 7, wherein the detectability estimation unit estimates the likelihood of successful peak detection based on the ratio of (i) the difference between the maximum value of the cross-correlation spectrum and its average value to (ii) the standard deviation of the cross-correlation spectrum.

(Supplementary Note 11) The signal processing system according to any one of Supplementary Notes 1 to 10, wherein the correlation shaping processing unit shapes the peak of the cross-correlation spectrum by performing arithmetic processing to calculate the moving average of the square of a normalized cross-correlation spectrum.

(Supplementary Note 12) The signal processing system according to any one of Supplementary Notes 1 to 10, wherein the correlation shaping processing unit shapes the peak of the cross-correlation spectrum by performing arithmetic processing to subtract a constant value from the moving average of the square of a normalized cross-correlation spectrum.

(Supplementary Note 13) The signal processing system according to any one of Supplementary Notes 1 to 10, wherein the correlation shaping processing unit shapes the peak of the cross-correlation spectrum by performing arithmetic processing to calculate the moving average of the square of the cross-correlation spectrum normalized for the result of subtracting a constant value from the moving average of the squares of the normalized cross-correlation spectrum.

(Supplementary Note 14) The signal processing system according to any one of Supplementary Notes 1 to 13, used for time alignment of received signals in spatial-mode multiplexed optical signal communication using a multi-core fiber.

(Supplementary Note 15) The signal processing system according to any one of Supplementary Notes 1 to 13, used for time alignment of received signals in propagation-mode multiplexed optical signal communication using a multi-mode fiber.

(Supplementary Note 16) The signal processing system according to any one of Supplementary Notes 1 to 13, used for time alignment of received signals in polarization-multiplexed optical signal communication using a single-mode fiber.

(Supplementary Note 17) A multi-signal processing system, wherein the signal processing system according to any one of Supplementary Notes 1 to 16 is arranged in parallel, and at least one of a parameter indicating characteristics of a transmission system or information indicating a modulation scheme of the pilot signal is input to each signal processing system.

(Supplementary Note 18) A signal processing method comprising:
calculating a cross-correlation spectrum representing similarity between each of multiple received signals, which have a temporal spread and are coupled to each other during propagation, and a pilot signal included in part of each of the received signal;
performing arithmetic processing that shapes the peak of the cross-correlation spectrum so that it becomes higher than an original peak;
detecting the peak of the cross-correlation spectrum after the arithmetic processing; and
performing time alignment that aligns a time origin to synchronize the pilot signal and the received signals by using the detected peak.

(Supplementary Note 19) The signal processing method according to Supplementary Note 18, further comprising:
determining a shaping parameter, which is a parameter used in the arithmetic processing of the cross-correlation spectrum, by using at least one of a parameter indicating characteristics of a transmission system or information indicating a modulation scheme of the pilot signal; and
performing the arithmetic processing by using the shaping parameter.

(Supplementary Note 20) A signal processing program for causing a computer to execute:
a cross-correlation calculation process of calculating a cross-correlation spectrum representing similarity between each of multiple received signals, which have a temporal spread and are coupled to each other during propagation, and a pilot signal included in part of each of the received signal;
a correlation shaping process of performing arithmetic processing that shapes the peak of the cross-correlation spectrum so that it becomes higher than an original peak;
a first peak determination process of detecting the peak of the cross-correlation spectrum after the arithmetic processing; and
a synchronization process of performing time alignment that aligns a time origin to synchronize the pilot signal and the received signals by using the detected peak.

(Supplementary Note 21) The signal processing program according to Supplementary Note 20, for causing a computer to execute a parameter determination process of determining, by using at least one of a parameter indicating characteristics of a transmission system or information indicating the modulation scheme of the pilot signal, a shaping parameter that is a parameter used in the arithmetic processing of the cross-correlation spectrum,
Wherein, in the correlation shaping process, the arithmetic processing is performs by using the shaping parameter.

While the present disclosure has been explained with reference to example embodiments, the present disclosure is not limited to the above example embodiments. Various modifications may be made to the configurations and details of the present disclosure within the scope of the present disclosure as understood by those skilled in the art. Moreover, the respective example embodiments may be combined with each other as appropriate.

### INDUSTRIAL APPLICABILITY

The present invention can be suitably applied to a signal processing system that processes optical signals. Specifically, the present invention can be applied to time alignment required for data-aided signal processing that uses a pilot signal in optical communication transmission with an optical fiber producing mode dispersion.
100, 200, 300, 400 Signal processing system
101 Cross-correlation calculation unit
102 Correlation shaping processing unit
103 Peak determination processing unit
104 Synchronization processing unit
201 Cross-correlation calculation unit
202 Parameter determination unit
203 Correlation shaping processing unit
204 Peak determination processing unit
205 Synchronization processing unit
301 Cross-correlation calculation unit
302 Preliminary peak determination processing unit
303 Branching processing unit
304 Correlation shaping processing unit
305 Subsequent peak determination processing unit
306 Synchronization processing unit
401 Cross-correlation calculation unit
402 Detectability estimation unit
403 Branching processing unit
404 Correlation shaping processing unit
405 Peak determination processing unit
406 Synchronization processing unit
500, 600, 700, 800 Signal processing device
510, 610, 710, 810 Time alignment device
5n0, 6n0, 7n0, 8n0 Time alignment device (n=2−8)
511 Cross-correlation calculation device
512 Correlation shaping device
513 Peak determination device
514 Synchronization processing device
611 Cross-correlation calculation device
612 Parameter determination device
613 Correlation shaping device
614 Peak determination device
615 Synchronization processing device
711 Cross-correlation calculation device
712 Preliminary peak determination device
713 Branching device
714 Correlation shaping device
715 Subsequent peak determination device
716 Synchronization processing device
811 Cross-correlation calculation device
812 Detectability estimation device
813 Branching device
814 Correlation shaping device
815 Peak determination device
816 Synchronization processing device

1. A signal processing system comprising:
a memory storing instructions; and
one or more processors configured to execute the instructions to:
calculate a cross-correlation spectrum representing similarity between each of multiple received signals, which have a temporal spread and are coupled to each other during propagation, and a pilot signal included in part of each of the received signals;
perform arithmetic processing that shapes the peak of the cross-correlation spectrum so that it becomes higher than an original peak;
detect the peak of the cross-correlation spectrum after the arithmetic processing; and
perform time alignment that aligns a time origin to synchronize the pilot signal and the received signals by using the detected peak.

2. The signal processing system according to claim 1, wherein the processor is configured to execute the instructions to:
determine a shaping parameter, which is a parameter used in the arithmetic processing of the cross-correlation spectrum, by using at least one of a parameter indicating characteristics of a transmission system or information indicating a modulation scheme of the pilot signal; and
perform the arithmetic processing by using the shaping parameter.

3. The signal processing system according to claim 2, wherein the processor is configured to execute the instructions to determine the shaping parameter by using the product of spatial mode dispersion, transmission distance, and sample rate.

4. The signal processing system according to claim 1, wherein the processor is configured to execute the instructions to detect the peak of the cross-correlation spectrum by using, as a threshold for peak detection, a value obtained by multiplying the average value of the cross-correlation spectrum after arithmetic processing by a constant.

5. The signal processing system according to claim 1, wherein the processor is configured to execute the instructions to:
detect the peak of the cross-correlation spectrum before arithmetic processing is performed;
perform the arithmetic processing on the cross-correlation spectrum if no peaks are detected in the cross-correlation spectrum before the arithmetic processing is performed; and
detect the peak of the cross-correlation spectrum after the arithmetic processing.

6. The signal processing system according to claim 5, wherein the processor is configured to execute the instructions to detect the peak of the cross-correlation spectrum by using, as a threshold for peak detection, a value obtained by multiplying the average value of the cross-correlation spectrum by a constant.

7. The signal processing system according to claim 1, wherein the processor is configured to execute the instructions to:
estimate the likelihood of successful peak detection by using an index that distinguishes the magnitude of the peak in the cross-correlation spectrum from that of non-peak portions; and
perform arithmetic processing on the cross-correlation spectrum if the likelihood is lower than a predetermined standard.

8. A multi-signal processing system comprising a parallel arrangement of the signal processing system according to claim 1,
wherein at least one of a parameter indicating characteristics of a transmission system or information indicating a modulation scheme of the pilot signal is input to each signal processing system.

9. A signal processing method comprising:
calculating a cross-correlation spectrum representing similarity between each of multiple received signals, which have a temporal spread and are coupled to each other during propagation, and a pilot signal included in part of each of the received signals;
performing arithmetic processing that shapes the peak of the cross-correlation spectrum so that it becomes higher than an original peak;
detecting the peak of the cross-correlation spectrum after the arithmetic processing; and
performing time alignment that aligns a time origin to synchronize the pilot signal and the received signals by using the detected peak.

10. A non-transitory computer readable information recording medium storing a signal processing program, when executed by a processor, that performs a method for:
calculating a cross-correlation spectrum representing similarity between each of multiple received signals, which have a temporal spread and are coupled to each other during propagation, and a pilot signal included in part of each of the received signals;
performing arithmetic processing that shapes the peak of the cross-correlation spectrum so that it becomes higher than an original peak;
detecting the peak of the cross-correlation spectrum after the arithmetic processing; and
performing time alignment that aligns a time origin to synchronize the pilot signal and the received signals by using the detected peak.
